(19) United States
(12) Patent Application Publication
(10) Pub. No.: US 2004/0133587 A1
(43) Pub. Date: Jul. 8, 2004

(54) Customer relationship management system

(76) Inventors: Takaaki Matsumoto, Kobe (JP); Takashi Saito, Kobe (JP); Yoshiyuki Yamashita, Oji (JP)

Correspondence Address: MATTINGLY, STANGER & MALUR, P.C., 1800 DIAGONAL ROAD, SUITE 370, ALEXANDRIA, VA, 22314, US

(21) Appl. No.: 10/614,083

(22) Filed: Jul. 8, 2003

(30) Foreign Application Priority Data
Jul. 12, 2002 (JP) 2002-203428
Jul. 4, 2003 (JP) 2003-191822

(51) Int. Cl. G06F 7/00

(52) U.S. Cl. 707/102

(57) ABSTRACT

When implementing a customer portal sit in a CRM system, fine service meeting respective customers can be provided, and labor required for creation and operation of the portal site is saved. Contents are managed in three classes: common contents for unspecific customers, default contents serving as defaults, and personal contents for specific customers. When creating default contents from the common contents, the default contents are created on the basis of a customer profile, a profile of a sales task member, and related information of other customers. The default contents are further processed with due regard to data of an individual customer to obtain personal contents. And the personal contents are used as data for display in the portal site of the customer.

### BACKGROUND OF THE INVENTION

The present invention relates to a CRM system, and in particular to a CRM system suitable for providing close service for customers by implementing customer portal sites specialized for respective customers.

In recent years, a CRM (Customer Relationship Management) system for constructing better relations between customers and an enterprise become the center of public interest in order to raise the satisfaction of customers. The CRM system is a system attempting to unitarily manage information, such as attribute information of customers (such as the sex distinctions, ages and tastes) and points of contact with the enterprise (such as sales task bases and sales task members), share the information over the whole enterprise, and utilize the information. Owing to the CRM system, all enterprise activities for forming and maintaining relations to customers can be utilized in a unified manner, and it becomes possible to construct and maintain deep reliable relations between customers and the enterprise.

On the other hand, in some cases, a customer portal site is established on the Internet as important means in the CRM system. The customer portal site is a web page group dedicated to each individual customer to provide each customer with specialized services collectively. In other words, if a customer inputs a user ID and a password in a log-in page in the customer portal site and authentication is performed, then the customer can reference a home page dedicated to the customer himself/herself and obtain necessary service there. Because of recent rapid spread of the Internet, it can be said that the customer portal site is the most important in providing customers with advanced service.

As a technique relating to such a customer portal site, a technique that makes it possible for a sales task member in charge to provide contents while talking with a customer in order to make the service provided for the customer more suit the desire of the customer is described in JP-A-2002-123667. According to this paper, a sales task member customizes common contents previously registered for unspecific customers, so as to satisfy needs of specific customers according to the following procedure, and provides the customized contents.

(1) On the basis of subject products for a customer the sales task member is in charge of and the sales task status, common contents are retrieved and their contents are ascertained.

(2) If customization is necessary, the contents of the common contents are edited. If customization is unnecessary, the common contents are used as they are.

(3) A customer of transmission destination for personal contents created by customizing the common contents is specified.

A technique concerning an access analysis system for discriminating service used by the customer in a service providing site is described in JP-A-2002-306947. According to this system, service utilized by the user can be discriminated from the access log by using a URL master for mapping a URL recorded in the access log to service provided in a web page.

In JP-A-2001-282982, a technique for analyzing and modeling the service purchase tendency on the basis of the profile and service purchase record of the customer and selecting an advertisement method for promising customers on the basis of the model is described.

Heretofore, contents carried in a typical customer portal site have been maintained by a member of staff in charge of creation of the contents. The staff is not in direct contact with the customer. Therefore, it is difficult for the staff to provide a wide variety of contents meeting needs of respective customers. Against the enterprise's intention, this often results in a problem that customers do not access the customer portal site so often.

In JP-A-2002-123667, a sales task member who is in close contact with a customer and who can know needs of the customer creates contents to be provided for the customer and thereby it is intended to solve the above-described problem.

In JP-A-2002-123667, however, the sales task member needs to customize common contents and provide customized contents for respective customers. This results in a problem that the sales task member in charge of a large number of customers spends much time to operate the customer portal site.

Furthermore, in JP-A-2002-306947 and JP-A-2001-282982, a best practice analysis of “great benefit with less labor” cannot be performed. Because in JP-A-2002-306947 and JP-A-2001-282982, an analysis concerning one axis, such as the number of service access times or the number of purchased articles, is performed, and a technique for making an analysis concerning labor required for creation and operation of a customer portal site and a profit commensurate with the labor is not incorporated.

### SUMMARY OF THE INVENTION

The present invention has been achieved in order to solve the problems. An object of the present invention is to provide a portal site creation method whereby a portal site capable of providing fine service meeting respective customers can be implemented when implementing a customer portal site in a CRM system and labor required for creation and operation of the portal site can be saved.

In portal site creation in a CRM system of the present invention, contents are managed in three classes: common contents for unspecific customers, default contents serving as defaults, and personal contents for specific customers.

When creating default contents from the common contents, the default contents are created on the basis of a customer profile, a profile of a sales task member, and related information of other customers. The default contents are further processed with due regard to data of an individual customer to obtain personal contents.

And the personal contents are used as data for display in the portal site of the customer.

The default contents are provided especially from a standpoint of a sales task member. The default contents are determined from the sales task member side. In addition, it is attempted to process the default contents as personal contents according to circumstances of an individual customer. As a result, the labor of a sales task member required for a portal site can be saved. In addition, the problem of providing a portal site close to an individual customer can be simultaneously solved.

Furthermore, there is also provided means for retrieving common contents having a high possibility of being needed by a customer, by using information contained in a customer profile and a sales task activity situation as a retrieval key.

In addition, there is also provided means for displaying a character string of a retrieval key or a paragraph containing the character string with emphasis. Other objects, features and advantages of the present invention will become apparent from the following description of the embodiments of the present invention taken in conjunction with the accompanying drawings.

### BRIEF DESCRIPTION OF THE DRAWINGS

FIG. 1 is a system configuration diagram of a CRM system according to an embodiment of the present invention;

FIG. 2 is a relation diagram of objects to be used in a CRM system according to an embodiment of the present invention;

FIG. 3 is a schematic diagram showing an example of a portlet management table;

FIG. 4 is a schematic diagram showing an example of a common contents management table;

FIG. 5 is a schematic diagram showing an example of a default customize data management table;

FIG. 6 is a schematic diagram showing an example of a personal customize data management table;

FIGS. 7A, 7B, 7C and 7D are schematic diagrams showing examples of tables for various kinds of relation information;

FIG. 8 is a schematic diagram showing an example of a doctor profile management table;

FIG. 9 is a schematic diagram showing an example of an MR profile management table;

FIG. 10 is a diagram showing relations at the time when retrieving contents from a doctor profile;

FIG. 11 is a diagram showing an outline of processing of creating common contents from general data;

FIG. 12 is a diagram showing an outline of processing of creating default customize data from common contents;

FIG. 13 is a diagram showing an outline of processing of creating personal customize data from default customize data;

FIG. 14 is a diagram showing relations from contents data to web page display in a CRM system 100 according to an embodiment of the present invention;

FIG. 15 is a diagram showing an example of a screen for collecting material data 111 in a CRM system 100 according to an embodiment of the present invention;

FIG. 16 is a diagram showing an example of a screen for creating common contents 112 in a CRM system according to an embodiment of the present invention;

FIG. 17 is a diagram showing an example of a screen for approving common contents 112 in a CRM system according to an embodiment of the present invention;

FIG. 18 is a diagram showing an example of a screen for creating default customize data 113 in a CRM system according to an embodiment of the present invention;

FIG. 19 is a diagram showing an example of a screen for approving default customize data 113 in a CRM system according to an embodiment of the present invention;

FIG. 20 is a diagram showing an example of a screen for creating personal customize data 114 in a CRM system 100 according to an embodiment of the present invention;

FIG. 21 is a diagram showing an example of a screen for confirming personal customize data 114 in a CRM system 100 according to an embodiment of the present invention;

FIG. 22 is a first diagram showing an example of a screen for doctor in a portal site in a CRM system 100;

FIG. 23 is a second diagram showing an example of a screen for doctor in a portal site in a CRM system 100;

FIG. 24 is a third diagram showing an example of a screen for doctor in a portal site in a CRM system 100;

FIG. 25 is a flow chart showing processing of creating common contents;

FIG. 26 is a flow chart showing processing of selecting common contents 112 relating to a doctor 12 an MR 11 is in charge of, on the basis of the specialty category;

FIG. 27 is a flow chart showing processing of selecting common contents 112 relating to a doctor 12 an MR 11 is in charge of, on the basis of the alma mater;

FIG. 28 is a flow chart showing processing of selecting common contents 112 relating to a doctor 12 an MR 11 is in charge of, on the basis of inter-doctor relation information 610;

FIG. 29 is a flow chart showing processing of selecting common contents 112 relating to a doctor 12 an MR 11 is in charge of, on the basis of the facility the doctor belongs to;

FIG. 30 is a flow chart showing processing of creating default customize data or personal customize data and obtaining approval;

FIG. 31 is a flow chart showing processing of creating personal customize data; and

FIG. 32 is a flow chart showing processing of displaying a doctor-oriented web page in a portal site in a CRM system 100.

### DESCRIPTION OF THE EMBODIMENTS

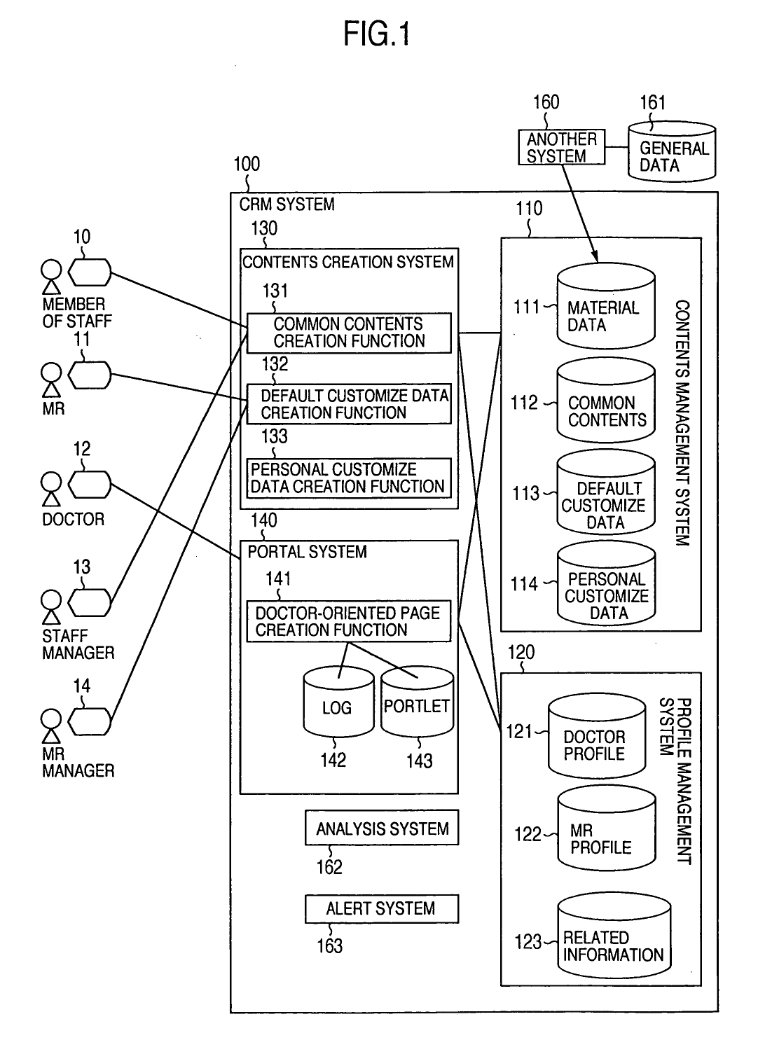

Hereafter, an embodiment of the present invention will be described with reference to FIGS. 1 to 32.

In the present embodiment, a model in which an enterprise that is a medicine manufacturing corporation provides a portal site for doctors who are customers will be described as an example of the CRM system. Furthermore, it is supposed that sales task members (medical representatives, hereafter referred to as MRs) of a medicine manufacturing corporation are arranged for doctors who are customers.

1. System Configuration of CRM System

First, a system configuration of a CRM system according to the present embodiment will now be described with reference to FIG. 1.

FIG. 1 is a system configuration diagram of a CRM system according to an embodiment of the present invention.

As shown in FIG. 1, a CRM system 100 according to the present embodiment includes a contents management system 110, a profile management system 120, a contents creation system 130, a portal system 140, an analysis system 162, and an alert system 163.

The contents management system 110 is a system for preserving and managing contents that become the basis of display contents in a portal site.

The profile management system 120 is a system for preserving and managing profiles of doctors and MRs.

The contents creation system 130 is a system for processing data and creating contents.

The portal system 140 is a system for dynamically creating a web page for doctor from data.

The analysis system 162 is a system for analyzing a web page access situation.

The alert system 163 is a system for monitoring writing to web pages and giving warning to an MR 11, an MR manager 14 and a staff 10.

As contents managed by the contents management system 110, there are material data 111, common contents 112, default customize data 113 and personal customize data 114.

The material data 111 is created on the basis of data taken in from another system 160, such as a SFA (Sales Force Automation) system, that handles general data 161. The material data 111 is data that becomes the basis for creating contents. By the way, the SFA is a system for making a business plan, and managing the progress and result of business.

The common contents 112 are contents data created on the basis of the material data 111 and used in common in the CRM system. The common contents 112 are created by the staff 10 by using a common contents creation function 131 of the contents creation system 130.

The default customize data 113 is data used for the MR 11 to create default contents on the basis of the common contents. The default customize data 113 is created by the MR 11 by using a default customize data creation function 132.

The personal customize data 114 is data for personal contents created by adding personal information of a customer to the default customize data 113. The personal customize data 114 is created by the MR 11 by using a personal customize data creation function 133.

If a problem about presentation or the like is found in the information of the common contents, the default customize data 113 and the personal customize data 114, then required data is transmitted from the contents creation system 130 to the alert system 163.

The contents creation system 130 is a system that executes programs for conducting processing required to create such contents. The functions may operate respectively as independent programs, or may be implemented by using one program.

The portal system 140 is a system that executes a program for conducting processing required to create a page to be displayed as a web site. The portal system 140 has a function of creating a web page and a function of operating a web system.

A doctor-oriented page creation function 141 is a function of creating a web page by using data in a log 142 and data in a portlet(s) 143.

If a doctor 12 accesses the CRM system 100 by using a computer, then a doctor-oriented web page is created by the doctor-oriented page creation function 141 in the portal system 140 by using the common contents 112, the default customize data 113, and the personal customize data 114. Here, an example in which a web page is created when access from a user such as a doctor is received (or when log-in processing or the like from the user is accepted) has been described. However, it is also possible to previously create data required to display on a computer used by the user and store the data in a storage device. Access information of the created web page is left in the log 142, and analyzed by the analysis system 162.

Information concerning access to the web page is managed in the log 142 according to every provided contents, every customer who has accessed and every web page creator (such as the MR or staff). By using these data in the log 142, the analysis system 162 can analyze as to when and which page is accessed by customers, who created a page accessed the largest number of times, and on the basis of which contents a web page that is the longest in perusal time has been created.

According to a result of the analysis, the manager of the portal site can find customers' tastes and an MR who created the web page that is perused the largest number of times. Therefore, an index for portal operation and web page creation is obtained.

In the computer 10 used by the staff, the computer 11 used by the MR, the computer 12 used by the doctor, the computer 13 used by the staff manager, and the computer 14 used by the MR manager, hardware resources (such as a CPU, a memory, and a hard disk) and software resources (such as an operating system and application programs) needed for business are included. Respective computers are connected to a network. Each of the computers conducts data transmission and reception with the CRM system 100 as occasion demands. The computers 10 to 14 may be portable terminals or portable telephones, or they may be other devices capable of conducting data transmission and reception with the CRM system 100.

2. Objects and Data Used in CRM System

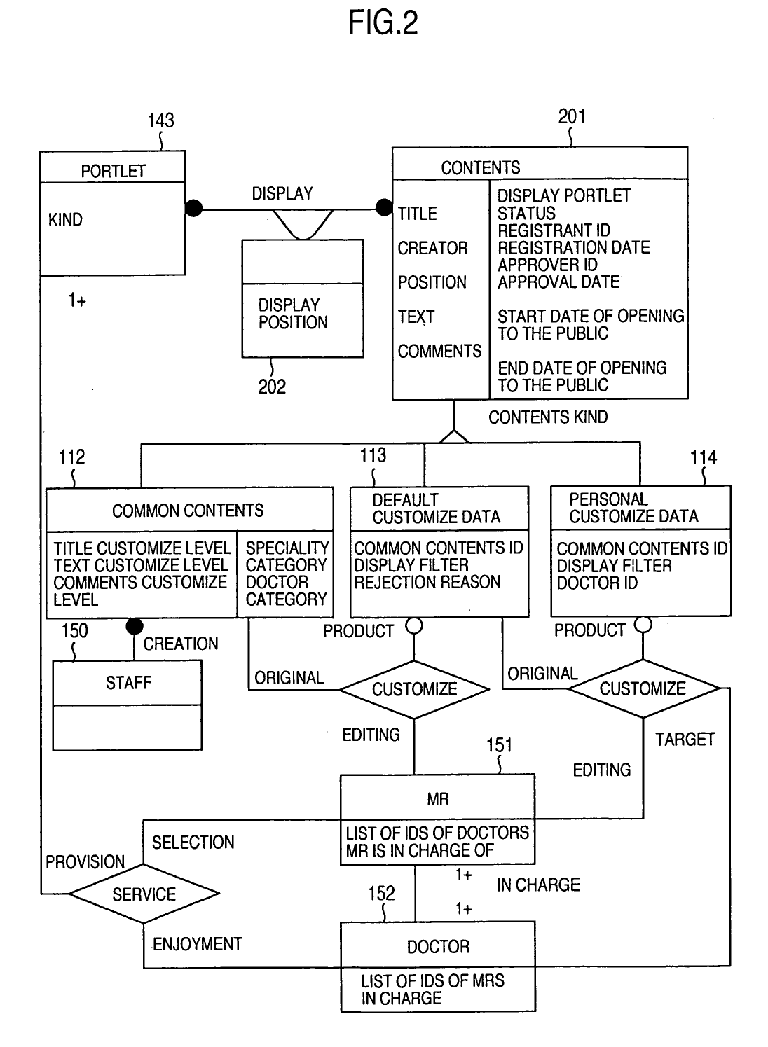

Objects and data used in the CRM system of the present embodiment will now be described with reference to FIGS. 2 to 14.

First, an outline of objects used in the CRM system of the present embodiment will be described with reference to FIG. 2.

FIG. 2 is a relation diagram of objects used in a CRM system according to an embodiment of the present invention.

For example, a class “doctor” 152 has a “list of IDs of MRs in charge” as an attribute. A class “MR” 151 has a “list of IDs of doctors MR is in charge of” as an attribute. Thus, a top part of each of boxes shown in FIG. 2 indicates a class name, whereas a bottom part of the box indicates an attribute of the class.

A rhomb and segments extending from the rhomb represent conducting processing. A symbol ● indicates correspondence of a plurality of objects, whereas a mark ◯ indicates correspondence of a single object. A symbol “1+” described under a box indicates that there are one or more objects.

On the basis of which service is provided for doctors, the MR 151 in charge selects a portlet 143. The portlet 143 displays zero or more contents 201 related thereto side by side. The portlet 143 is a display unit on the portal site. In FIG. 2, a loop added to a segment showing a relation between the portlet 143 and the contents 201 indicates a link attribute. As the link attribute, there is a display position 202.

The contents 201 include three kinds: the common contents 112, the default customize data 113 and the personal customize data 114. In FIG. 2, a triangle formed on a segment located under the contents box represents that there are three kinds of contents.

The common contents 112 are created by the staff 150. The default customize data 113 is created by customization of the common contents 112 conducted by the MR 151. In the present embodiment, it is assumed that one default customize data 113 is provided for each of combinations of the MR 151, the common contents 112 and the portlet 143, even if the default customize data 113 exists.

The personal customize data 114 is created by customization of the default customize data 113 conducted by the MR 11 in charge with the intention of providing a specific doctor 12 with information.

If it is attempted to create the personal customize data 114 directly from the common contents 112 in a state that there is no default customize data 113, then in the present embodiment the CRM system 100 creates the default customize data 113 having the same information as the common contents 112.

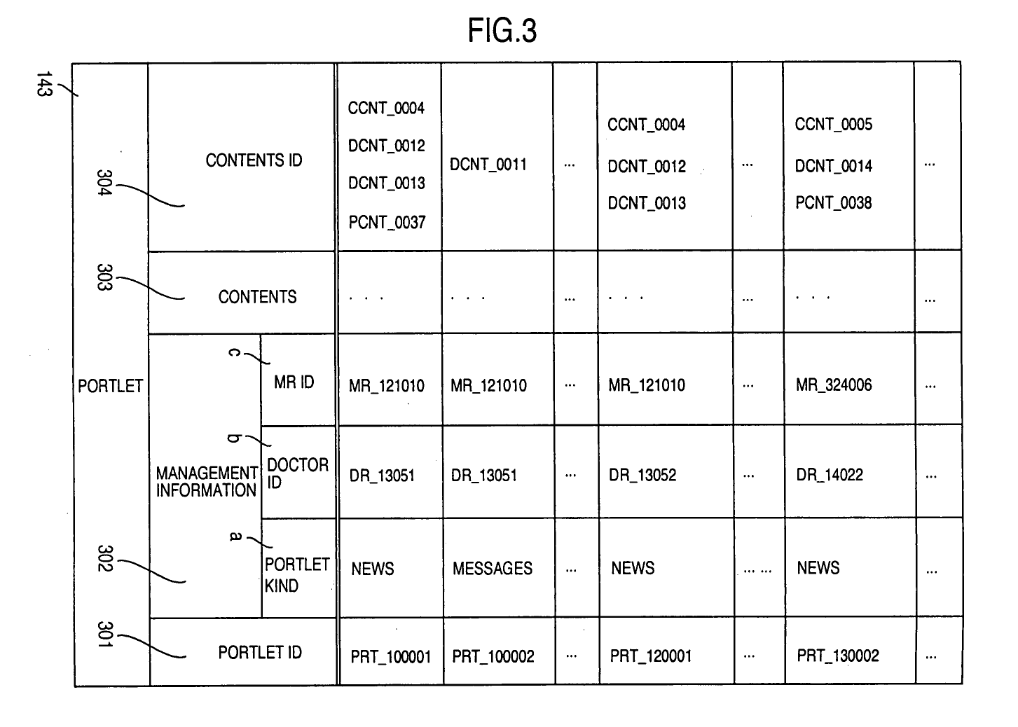

Concrete examples of data structures used in the CRM system according to an embodiment of the present invention will now be described with reference to FIGS. 3 to 9, in which:

FIG. 3 is a schematic diagram showing an example of a portlet management table;

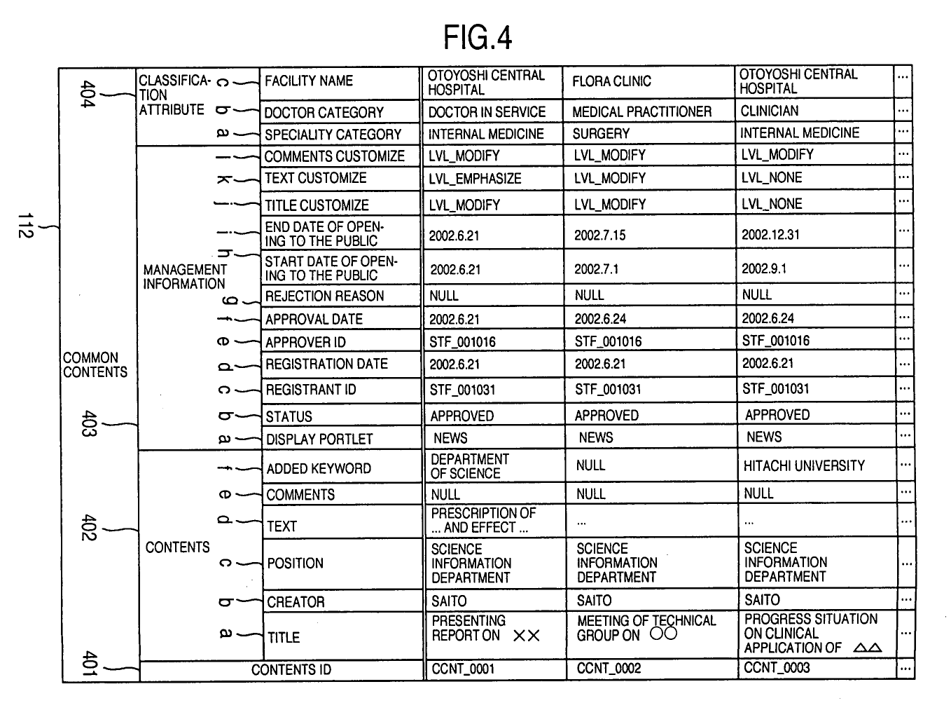

FIG. 4 is a schematic diagram showing an example of a common contents management table;

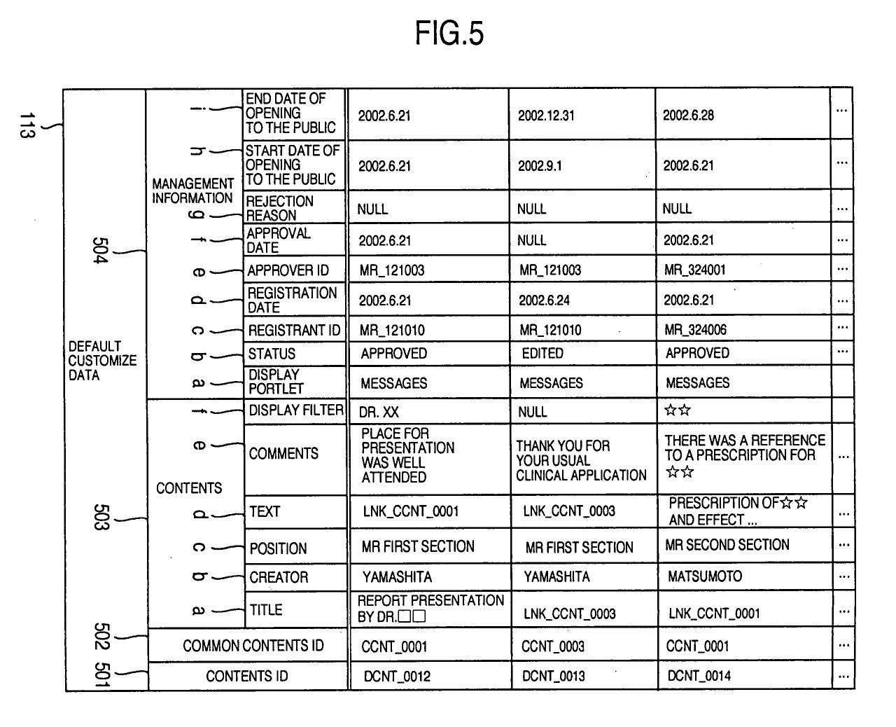

FIG. 5 is a schematic diagram showing an example of a default customize data management table;

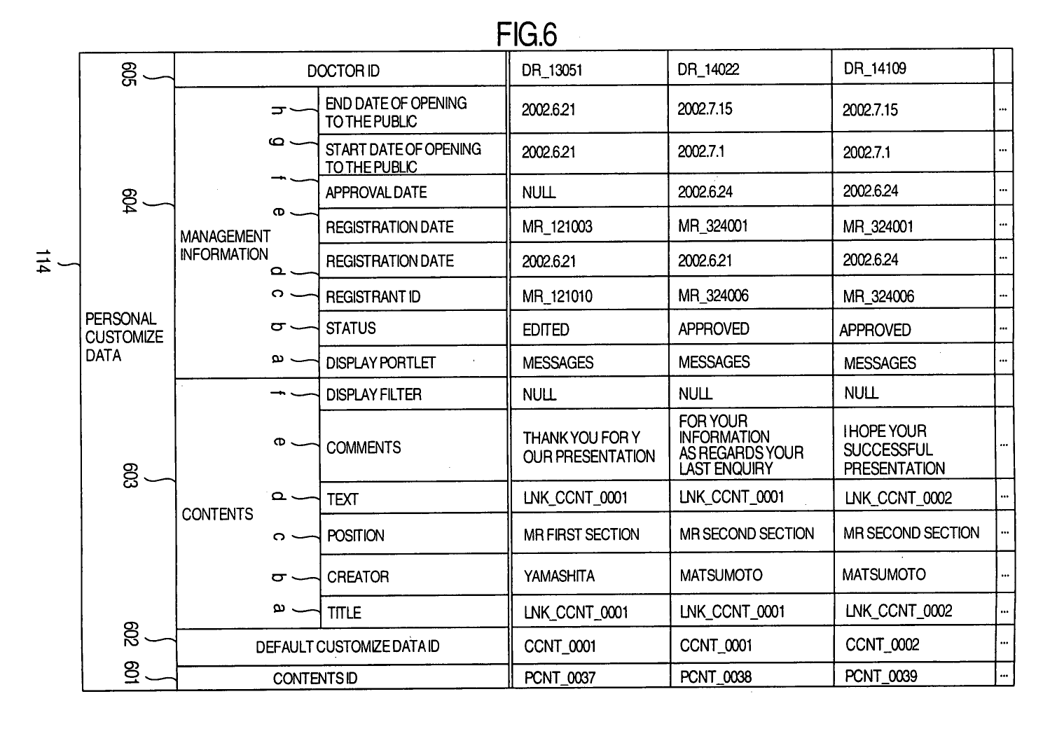

FIG. 6 is a schematic diagram showing an example of a personal customize data management table;

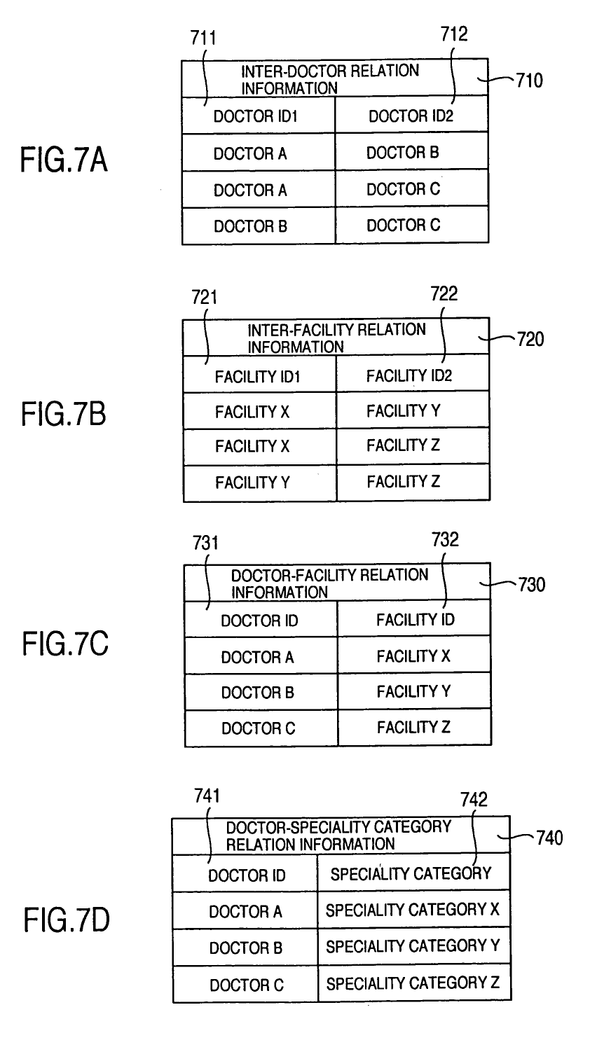

FIGS. 7A, 7B, 7C and 7D are schematic diagrams showing examples of tables for various kinds of relation information;

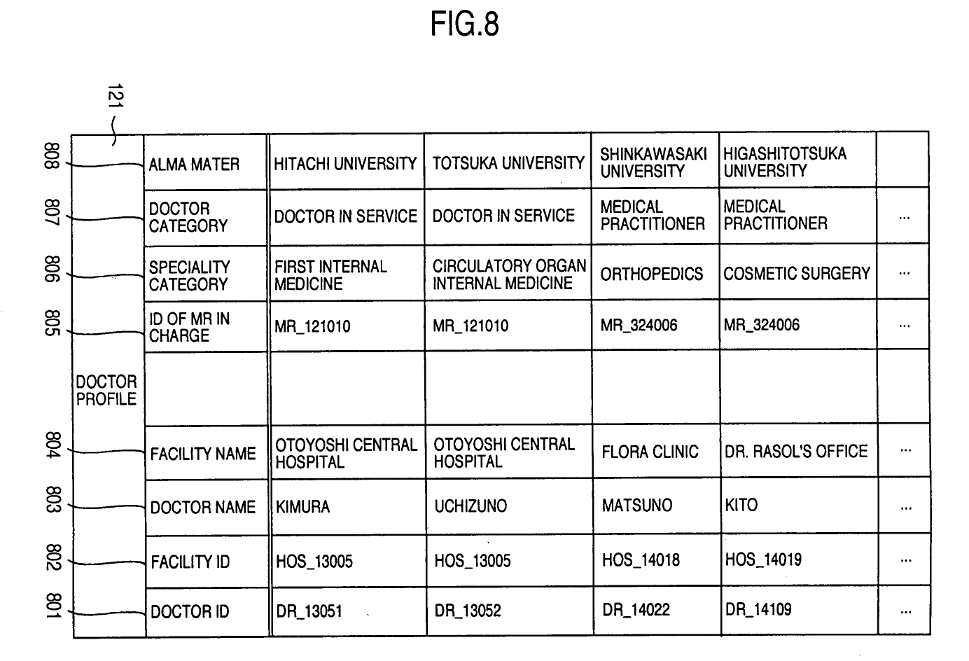

FIG. 8 is a schematic diagram showing an example of a doctor profile management table; and

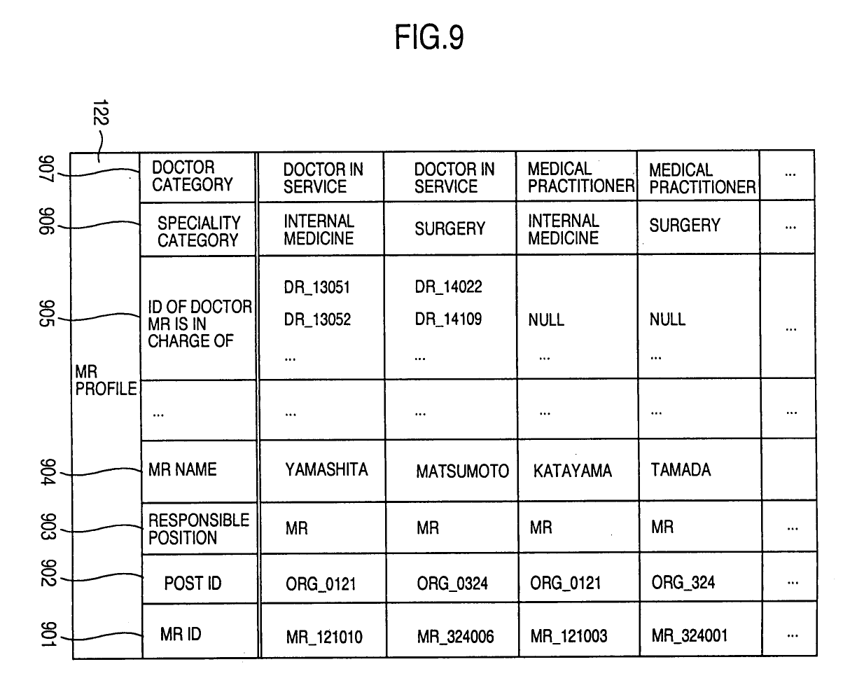

FIG. 9 is a schematic diagram showing an example of an MR profile management table.

As shown in FIG. 3, the portlet management table includes the following items.

Portlet ID 301: An identifier for uniquely identifying a portlet 143

Management information 302: It is information required for managing the portlet 143, and it includes the following three kinds of information in the present embodiment.

Portlet kind 302-a: A portlet kind such as bulletin board, message board, scheduler, and Q&A

Doctor ID 302-b: An identifier of a doctor to be provided with information

MR ID 302-c: An identifier of an MR that provides the information

Contents 303: Data of the portlet 143 itself (The contents 303 includes description of the portlet and market extension advertisement situation data.)

Contents ID 304: An identifier of contents 201 to be displayed in the portlet 143

In the description of the present embodiment, data are stored in a table and managed. However, this is merely an example, and information may be managed by using another method (such as a list structure or a tree structure).

A common contents management table for managing the common contents 112 includes the following items as shown in FIG. 4.

Contents ID 401: An identifier for uniquely identifying common contents 112

Contents 402: They include contents of the common contents 112, and include the following five kinds of information in the present embodiment.

Title 402-a: A title of the common contents 112

Creator 402-b: A creator name of the common contents 112

Position 402-c: A name of a post or facility to which the creator of the common contents 112 belongs

Text 402-d: A text of the common contents 112

Comments 402-e: Comments attached to the text of the common contents 112

Added keyword 402-f: Added keyword attached to the text of the common contents 112

Management information 403: It is information for managing the common contents 112, and it includes the following twelve kinds of information in the present embodiment.

Display portlet 403-a: A kind of the portlet 143 in which the common contents 112 are displayed

Status 403-b: A status of the common contents 112 (such as “under editing,” “already edited,” “already approved,” “rejected,” “waiting for opening to the public,” “under opening to the public,” and “terminated in opening to the public”)

Registrant ID 403-c: An identifier of a person who registered the common contents 112

Registration date 403-d: A date on which the common contents 112 were registered

Approver ID 403-e: An identifier of a person who approved the common contents 112

Approval date 403-f: A date on which the common contents 112 were approved

Reason for rejection 403-g: A reason in the case where rejection was effected in examination of the common contents 112

Start date of opening to the public 403-h: A date on which the common contents 112 are opened to the public (doctors). If its value is “null,” it is indicated that the common contents 112 are opened to the public on the same day if approved.

End date of opening to the public 403-i: A date on which opening of the common contents 112 to the public is terminated. If its value is “null,” it is indicated that the common contents 112 are opened to the public indefinitely until the MR explicitly specifies withdrawal.

Title customize 403-j: It indicates to what extent the title 402-a may be customized when creating the default customize data 113. In the present embodiment, there are two kinds: “alteration (:alteration of the text is possible)” and “emphasis (emphasized display of a part of the text is possible).” There are four ways: both of them are impossible, only one of them is possible, and both of them are possible.

Text customize 403-k: It indicates to what extent the text 402-d may be customized when creating the default customize data 113. Possible values are the same as those for the title customize 403-j.

Comments customize level 403-l: It indicates to what extent the comments 403-e may be customized when creating the default customize data 113. Possible values are the same as those for the title customize 403-j.

Classification attribute 404: It is an attribute for classifying the common contents 112, and it includes the following three kinds of information in the present embodiment.

Specialty category 404-a: It is an attribute classified according to the specialty of the doctor (such as “internal medicine,” “surgery,” “pediatrics,” “dermatology,” “otolaryngology,” “urology,” or “obstetrics and genecology”).

Doctor category 404-b: It is an attribute for classifying the doctor according to the working form, and it has a value such as “doctor in service,” “resident,” “medical practitioner,” or “clinician”.

Facility name 404-c: It is an attribute for classifying the doctor according to the facility name, and it has the name of the facility as a value.

A default customize data management table for managing the default customize data 113 includes the following items as shown in FIG. 5.

Contents ID 501: An identifier for uniquely identifying default customize data 113

Common contents ID 502: An identifier of the common contents 112 that have become the basis when creating the default customize data 113

Contents 503: They are contents of the default customize data 113, and they include the following six kinds of information in the present embodiment:

Title 503-a: It is a title of the default customize data 113. In the case where there are no alterations to the default customize data, it is link information to the common contents that have becomes the basis.

Creator 503-b: A creator name of the default customize data 113

Position 503-c: A name of a post or facility to which the creator of the default customize data 113 belongs

Text 503-d: It is a text of the default customize data 113. In the case where there are no alterations on the default customize data, it is link information to the common contents that have become the basis.

Comments 503-e: Comments attached to the text of the default customize data 113

Display filter 503-f: It indicates a filter used when displaying the title 503-a, the text 503-d and the comments 503-e. In the present embodiment, it specifies an input to a filter for conducting emphasis display of a keyword, i.e., a keyword desired to be displayed with emphasis.

Management information 504: It is information for managing the default customize data 113, and it includes the following nine kinds of information in the present embodiment.

Display portlet 504-a: A kind of the portlet 143 in which the default customize data 113 is displayed

Status 504-b: A status of the default customize data 113 (such as “under editing,” “already edited,” “already approved,” “rejected,” “waiting for opening to the public,” “under opening to the public,” and “terminated in opening to the public”)

Registrant ID 504-c: An identifier of a person who registered the default customize data 113

Registration date 504-d: A date on which the default customize data 113 was registered

Approver ID 504-e: An identifier of a person who approved the default customize data 113

Approval date 504-f: A date on which the default customize data 113 was approved

Reason of rejection 504-g: A reason in the case where rejection was effected in examination of the default customize data 113

Start date of opening to the public 504-h: A date on which the default customize data 113 is opened to the public (doctors). If its value is “null,” it is indicated that the default customize data 113 is opened to the public on the same day if approved.

End date of opening to the public 504-i: A date on which opening of the default customize data 113 to the public is terminated. If its value is “null,” it is indicated that the default customize data 113 is opened to the public indefinitely until the MR explicitly specifies withdrawal.

A personal customize data management table for managing the personal customize data 114 includes the following items as shown in FIG. 6.

Contents ID 601: An identifier for uniquely identifying personal customize data 114

Default customize data ID 602: An identifier of default customize data 113 that has become the basis when creating the personal customize data 114

Contents 603: They are contents of the personal customize data 114, and they include the following six kinds of information in the same way as the case of the default customize data 113:

Title 603-a: It is a title of the personal customize data 114. In the case where there are alterations neither on the default customize data nor on the personal customize data, it is link information to the common contents that have become the basis.

Creator 603-b: A creator name of the personal customize data 114

Position 603-c: A name of a post or facility to which the creator of the personal customize data 114 belongs

Text 603-d: It is a text of the personal customize data 114. In the case where there are no alterations neither on the default customize data nor on the personal customize data, it is link information to the common contents that have become the basis.

Comments 603-e: Comments attached to the text of the personal customize data 114

Display filter 603-f: It indicates a filter used when displaying the title 603-a, the text 603-d and the comments 603-e. In the present embodiment, it specifies an input to a filter for conducting emphasis display of a keyword, i.e., it specifies a keyword desired to be displayed with emphasis.

Management information 604: It is information for managing the personal customize data 114, and it includes the following eight kinds of information in the present embodiment.

Display portlet 604-a: A kind of the portlet 143 in which the personal customize data 114 is displayed

Status 604-b: A status of the personal customize data 114 (such as “under editing,” “already edited,” “already approved,” “rejected,” “waiting for opening to the public,” “under opening to the public,” and “terminated in opening to the public”)

Registrant ID 604-c: An identifier of a person who registered the personal customize data 114

Registration date 604-d: A date on which the personal customize data 114 was registered

Approver ID 604-e: An identifier of a person who approved the personal customize data 114

Approval date 604-f: A date on which the personal customize data 114 was approved

Start date of opening to the public 604-g: A date on which the personal customize data 114 is opened to the public (doctors). If its value is “null,” it is indicated that the personal customize data 114 is opened to the public on the same day if approved.

End date of opening to the public 604-h: A date on which opening of the personal customize data 114 to the public is terminated. If its value is “null,” it is indicated that the personal customize data 114 is opened to the public indefinitely until the MR explicitly specifies withdrawal.

As examples of the relation information 123, for example, examples shown in FIGS. 7A, 7B, 7C and 7D are conceivable.

Inter-doctor relation information 710 (FIG. 7A): It is a table for managing two doctors who are in a friend relation, a relation in work such as a joint research, or the like. Identifiers of doctors having relations to a doctor ID1 711 and a doctor ID2 712 are registered.

Inter-facility relation information 720 (FIG. 7B): It is a table for managing two facilities that are in a certain relation, such as the same university group. Identifiers of facilities having relations to a facility ID1 721 and a facility ID2 722 are registered.

Doctor-facility relation information 730 (FIG. 7C): It is a table for managing facilities having relations to doctors, such as facilities in which doctors work part-time. Identifiers of doctors and facilities respectively having relations to a doctor ID 731 and a facility 732 are registered.

Doctor-specialty category relation information 740 (FIG. 7D): It is a table for managing categories of specialties doctors are interested in. An identifier of a doctor is registered in a doctor ID 741, and a coded specialty (such as “internal medicine” or “surgery”) is registered in an specialty category 742.

A doctor profile management table for managing the doctor profile 121 includes the following items as shown in FIG. 8.

Doctor ID 801: An identifier for uniquely identifying a doctor

Facility ID 802: An identifier for uniquely identifying a facility in which the doctor works or manages

Doctor name 803: A name of the doctor

Facility name 804: A name of the facility in which the doctor works or manages

ID 805 of MR in charge: An identifier of an MR in charge of the doctor. In the case where a plurality of MRs are in charge of one doctor, a list of identifiers of a plurality of MRs is used.

Specialty category 806: A specialty of the doctor, such as “internal medicine” or “surgery.”

Doctor category 807: An attribute indicating the working form of the doctor, such as “doctor in service,” “medical practitioner,” “resident,” or “clinician”.

Alma mater 808: An identifier of a university the doctor graduated from

An MR profile management table for managing the MR profile 122 includes the following items as shown in FIG. 9.

MR ID 901: An identifier for uniquely identifying an MR

Post ID 902: An identifier for uniquely identifying the post the MR belongs to

Responsible position 903: A code of the responsible position of the MR

MR name 904: A name of the MR

ID 905 of doctor MR is in charge of: An ID of a doctor the MR is in charge of. In the case where the MR is in charge of a plurality of doctors, it becomes a list of doctor IDs.

Specialty category 906: A category of a specialty the MR is in charge of

Doctor category 907: A category, such as a working form, of a doctor the MR is in charge of

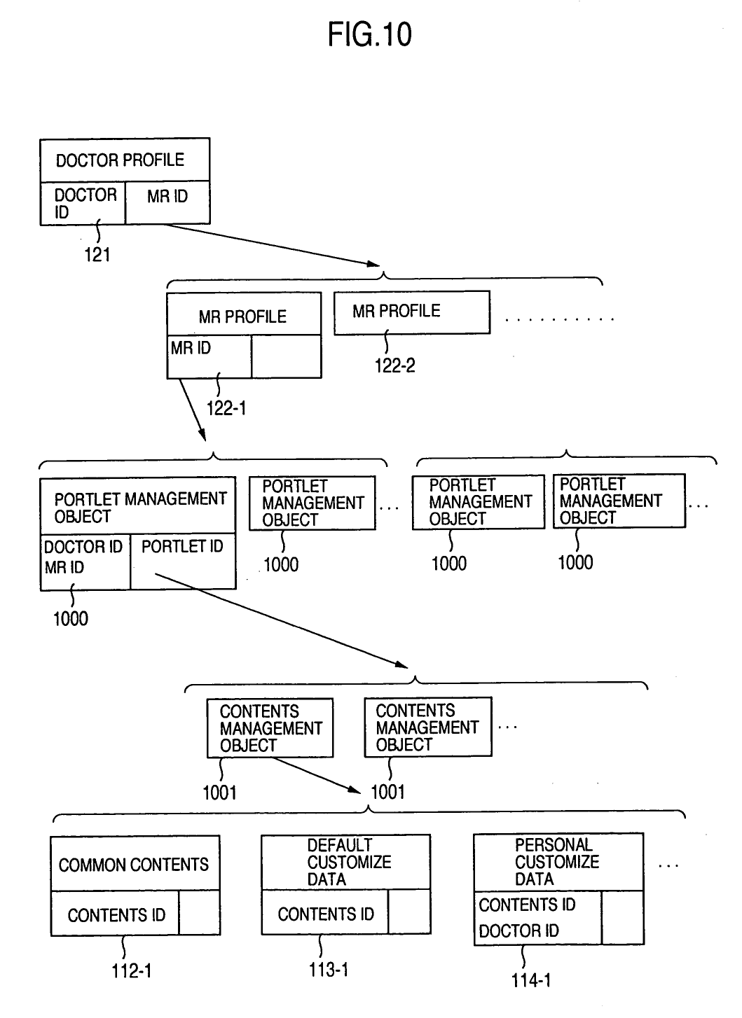

Link relations for contents retrieval will now be described with reference to FIG. 10.

FIG. 10 is a diagram showing relations to be used when retrieving contents from the doctor profile.

When some doctor has logged in the CRM system 100, the links as shown in FIG. 10 are followed and contents to be displayed are determined.

A pertinent MR profile is retrieved on the basis of the ID of the MR in charge in the doctor profile. And a portlet management object having the ID of the MR is retrieved.

Portlet management objects 1000 are instance objects, which indicate individual portlets each having the table structure for portlet management shown in FIG. 3. A portlet management object 1000 retrieves a corresponding contents management object on the basis of an individual portlet ID. A contents management object is an object for managing the common contents, the default customize data and the personal customize data with respect to a set of a doctor, an MR and a portlet. In this way, contents to be displayed for a portlet of a doctor who has logged in are retrieved.

When describing the processing of display page generation later, FIG. 10 will be cited.

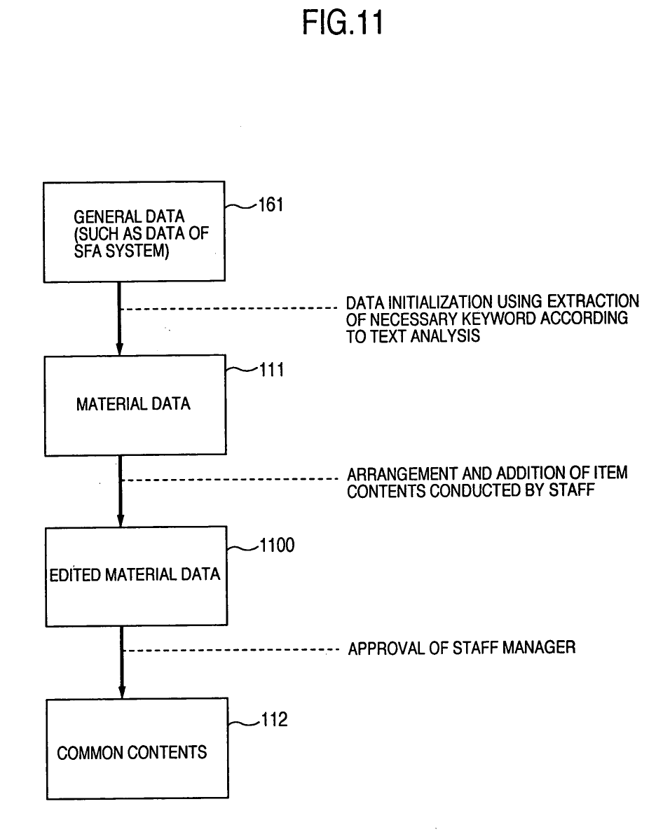

An outline of processing of creating the personal customize data from the general data will now be described with reference to FIGS. 11 to 13.

FIG. 11 is a diagram showing an outline of processing of creating the common contents from the general data.

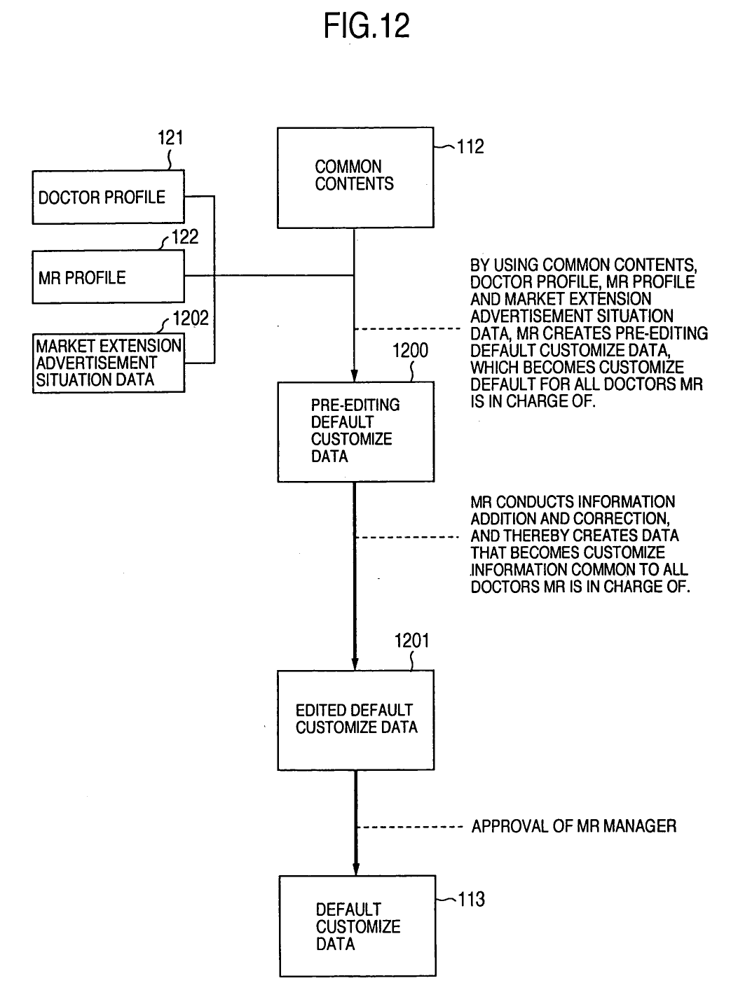

FIG. 12 is a diagram showing an outline of processing of creating the default customize data from the common contents.

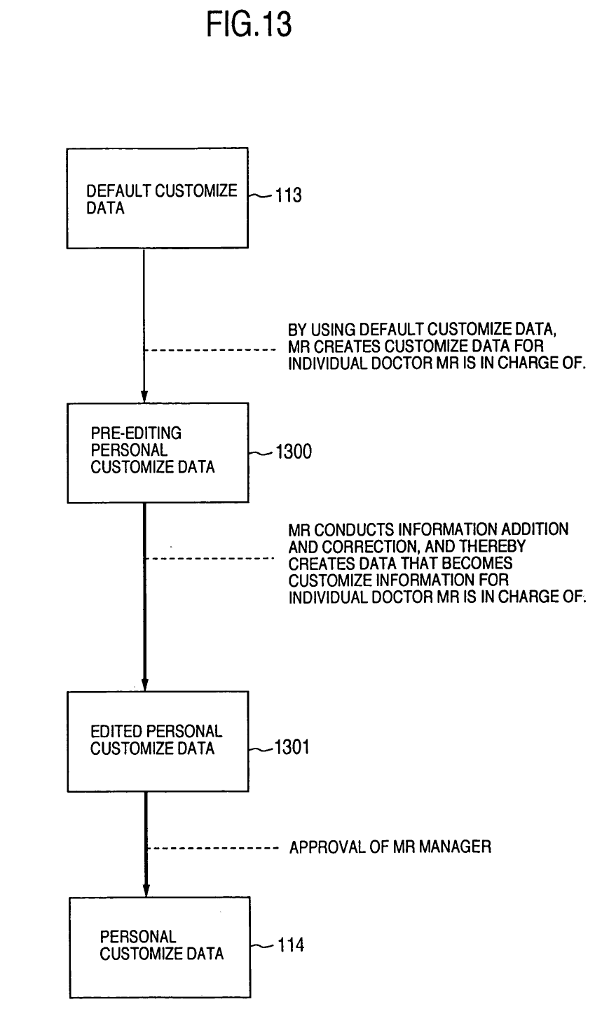

FIG. 13 is a diagram showing an outline of processing of creating the personal customize data from the default customize data.

As shown in FIG. 11, with respect to the general data 161, initialization of contents in data items using necessary keyword extraction is conducted by analyzing the contents, and the material data 111 is created. In this stage, raw data considered necessary, such as product presentation and new arrival information, are extracted.

Subsequently, the staff conducts arrangement and addition of contents of data items on the material data 111, and thereby creates edited material data 1100. As a result of approval of the edited material data 1100 conducted by a staff manager 13, it becomes common contents 112.

In a stage of creating the default customize data from the common contents, the process shown in FIG. 12 is effected.

By using the common contents 112, the doctor profile 121, the MR profile 122, and market extension advertisement situation data 1202, the MR 11 creates pre-editing default customize data 1200, which becomes the customize default for all doctors the MR 11 is in charge of. Here, market extension advertisement situation data is data that represents the situation at the time when sales task activity such as advertisement is conducted.

Subsequently, the MR 11 conducts information addition and correction, and thereby creates edited default customize data 1201.

As a result of approval of the edited default customize data 1201 conducted by the MR manager 14, it becomes default customize data 113.

In other words, it can be said that the default customize data 113 is customize data corresponding to the MR 11 in charge.

In a stage of creating personal customize data from default customize data, a process shown in FIG. 13 is effected.

First, pre-editing personal customize data 1300, which becomes customize data for each individual doctor the MR 11 is in charge of, is created by using the default customize data. Subsequently, the MR 11 conducts information addition and correction, and thereby creates edited personal customize data 1301. As a result of approval of the edited personal customize data 1301 conducted by the MR manager 14, personal customize data 114 is obtained.

It can be said that the personal customize data is final customize data corresponding to the doctor who is a customer.

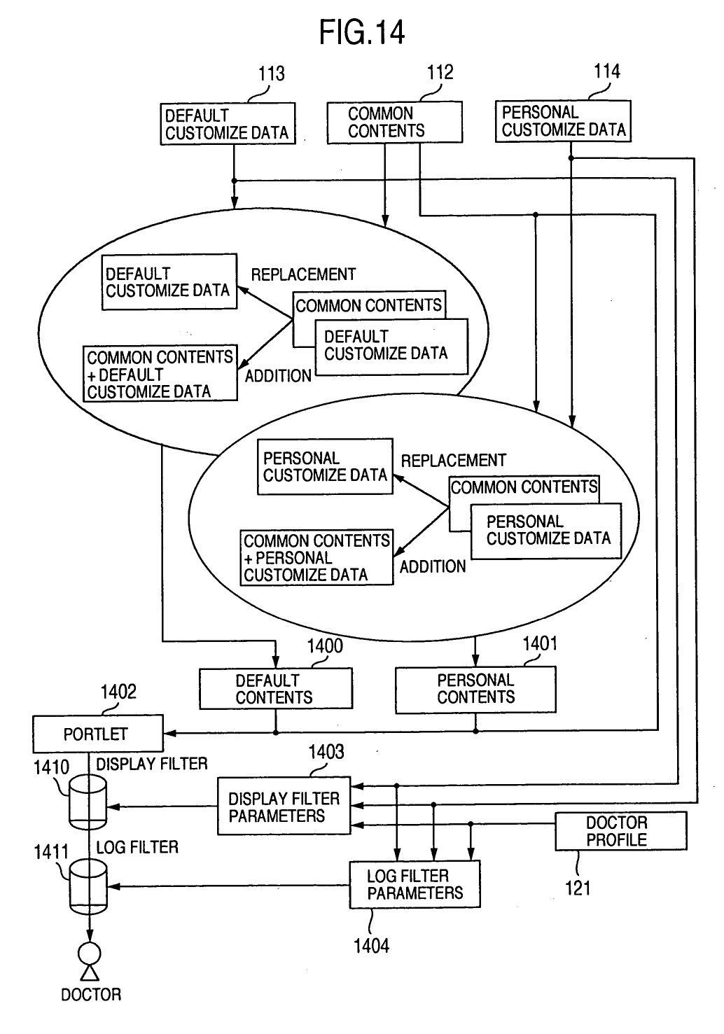

Relations from contents data to display in the CRM system 100 in the present embodiment will now be described with reference to FIG. 14.

FIG. 14 is a diagram showing relations from contents data to web page display in the CRM system 100 according to an embodiment of the present invention.

As shown in FIG. 14, default contents 1400 are generated by using the common contents 112 and the default customize data 113. In the case where the customize condition is replacement, the default contents 1400 are generated by using data in the default customize data 113. In the case where the customize condition is addition, the default contents 1400 are generated by adding data in the default customize data 113 to the data in the common contents 112.

Personal contents 1401 are generated by using the common contents 112 and the personal customize data 114. In the case where the customize condition is replacement, the personal contents 1401 are generated by using data in the personal customize data 114. In the case where the customize condition is addition, the personal contents 1401 are generated by adding data in the personal customize data 114 to the data in the common contents 112.

After the contents have been created, a portlet 1402 including some default contents 1400 and some personal contents 1401 is created.

Furthermore, display filter parameters 1403 and log filter parameters 1404 are created from the doctor profile 121 and the default customize data 113.

A display filter 1410 and a log filter 1411 alter the contents of the portlet 1403 on the basis of the display filter parameters 1403 and the log filter parameters 1404, respectively.

A web page obtained after the alterations effected by the filters is displayed in the portal site for the doctor.

3. User Interfaces Provided by CRM System

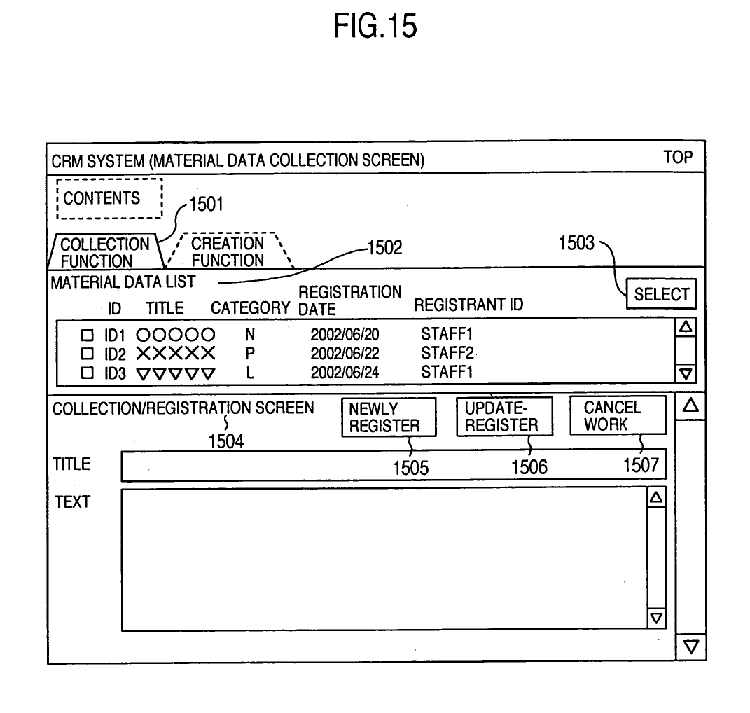

User interfaces provided by the CRM system according to an embodiment of the present invention will now be described with reference to FIGS. 15 to 24.

First, a user interface concerning collection of material data will now be described with reference to FIG. 15.

FIG. 15 is a diagram showing an example of a collection screen for the material data 111 in the CRM system 100 according to an embodiment of the present invention.

The staff 10 opens a collection screen for the material data 111, and selects a tab of a collection function 1501.

Subsequently, by depressing a collection button 1503, a list 1502 of the material data 111 collected from the general data 161 by means of a text analysis using a preset keyword is displayed as a material data list 1502. And by selecting a subject material from the material data list 1502 and depressing a selection button 1503, the contents can be displayed on a collection/registration screen 1504.

If the displayed contents are edited or contents are newly input and a registration button 1505 is depressed, then they are registered as new material data. If the displayed contents are edited and an update button 1506 is depressed, then contents of the material data are updated. If a cancel button 1507 is depressed, then alterations are canceled.

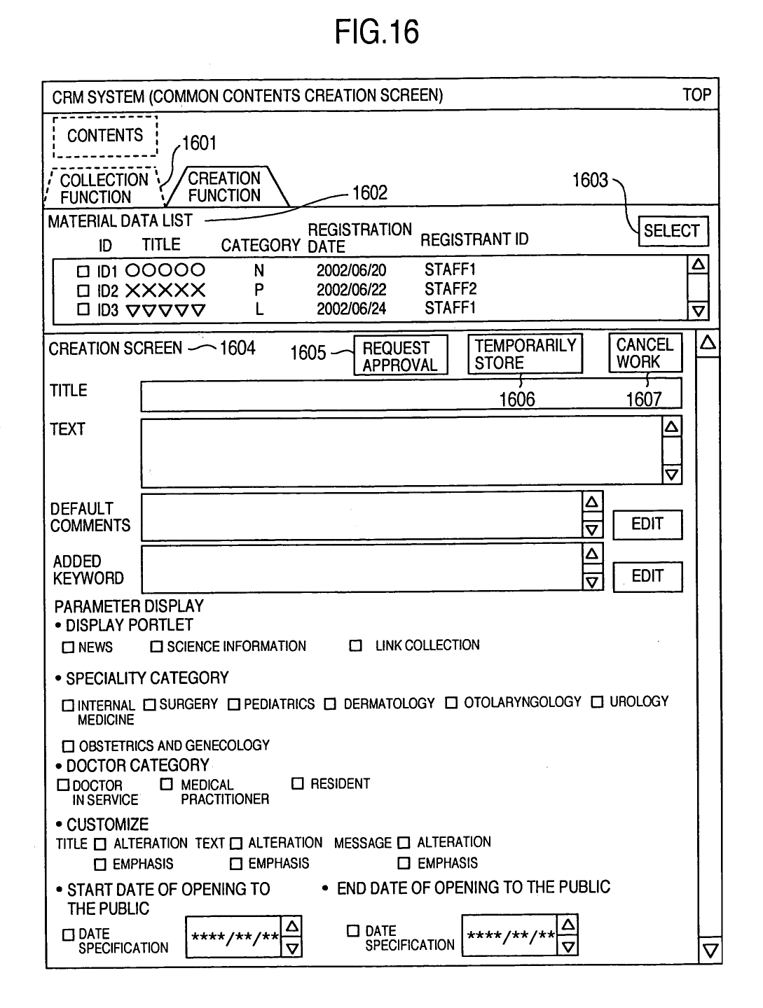

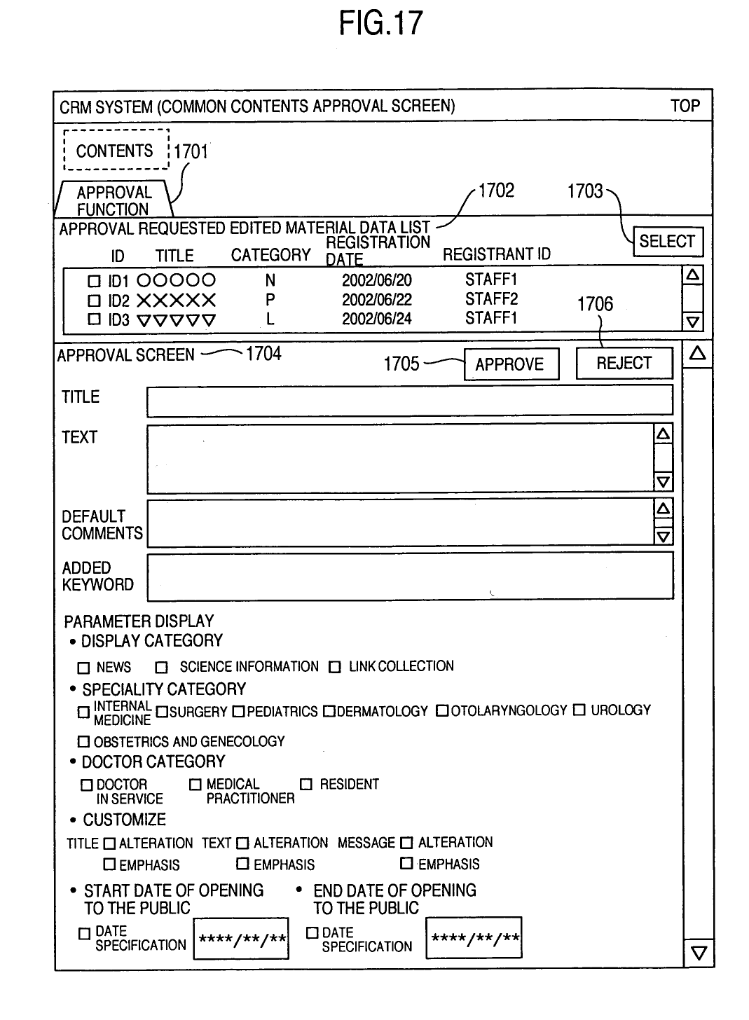

The user interface concerning the common contents will now be described with reference to FIGS. 16 and 17.

FIG. 16 is a diagram showing an example of a creation screen for the common contents 112 in the CRM system 100 according to an embodiment of the present invention.

FIG. 17 is a diagram showing an example of an approval screen for the common contents 112 in the CRM system 100 according to an embodiment of the present invention.

As shown in FIG. 16, the staff 10 opens the creation screen for the common contents 112 and selects a creation function tab 1601 and thereby displays a list 1602 of collected material data 111 (1602).

By selecting material data 111 to be edited and depressing a selection button 1603, the contents are displayed on a creation screen 1604. By conducting arrangement or addition on contents of data items with respect to the material data 111 displayed on the creation screen 1604 as the staff 10 demands, edited material data 1100 is created.

Comparing display contents shown in FIG. 16 with the data shown in FIG. 4, a title in the creation screen corresponds to the title (402-a in FIG. 4) in the contents in the common contents, and a text corresponds to the text (402-d in FIG. 4) in the contents in the common contents. Default comments corresponds to the comments (402-e in FIG. 4) in the contents in the common contents, and a display category corresponds to the display portlet (403-a in FIG. 4) in the management information in the common contents. A specialty category corresponds to the specialty category (404-a in FIG. 4) in the classification attribute in the common contents, and a doctor category corresponds to the doctor category (404-b in FIG. 4) in the classification attribute in the common contents. A customize corresponds to the title customize (403-j in FIG. 4), the text customize (403-k in FIG. 4) and the comments customize (403-l in FIG. 4) in the management information in the common contents. A start date of opening to the public corresponds to the start date of opening to the public (403-h in FIG. 4) in the management information in the common contents, and an end date of opening to the public corresponds to the end date of opening to the public (403-i in FIG. 4) in the management information in the common contents. By editing items on the screen, data in the common contents management table shown in FIG. 4 are updated.

In the case where default customize data has been created by customizing the common contents, a check box “emphasis” is checked off when emphasizing the display on the web.

By depressing an approval request button 1605 after the editing has been completed, the staff manager 153 is requested to approve the edited material data 1100.

On the other hand, if a temporary storage button 1605 is depressed, then an approval request is not issued, but the contents are updated, and the status (403-b in FIG. 4) in the management information in the common contents is stored in the state of the material data under editing.

If a work cancel button 1607 is depressed, then alteration contents are not stored, but discarded.

If an approval request of the common contents is issued by the staff 10, then the staff manager 13 opens an approval screen for the common contents 112 shown in FIG. 17. And the staff manager 13 selects a tab for an approval function 1701 and thereby displays a list 1702 of the edited material data 1100 (1702).

If the staff manager 13 selects the displayed edited material data 1100 and depresses a selection button 1703, then contents are displayed on an approval screen 1704. The staff manager 13 checks the contents. When approving the edited material data 1100 as the common contents 112, the staff manager 13 depresses an approval button 1705. When not approving the edited material data 1100 as the common contents 112, the staff manager 13 depresses a rejection button 1706. When the staff manager 13 has rejected, the staff manager 13 opens a different window for inputting a reason of the rejection, and inputs the reason of the rejection.

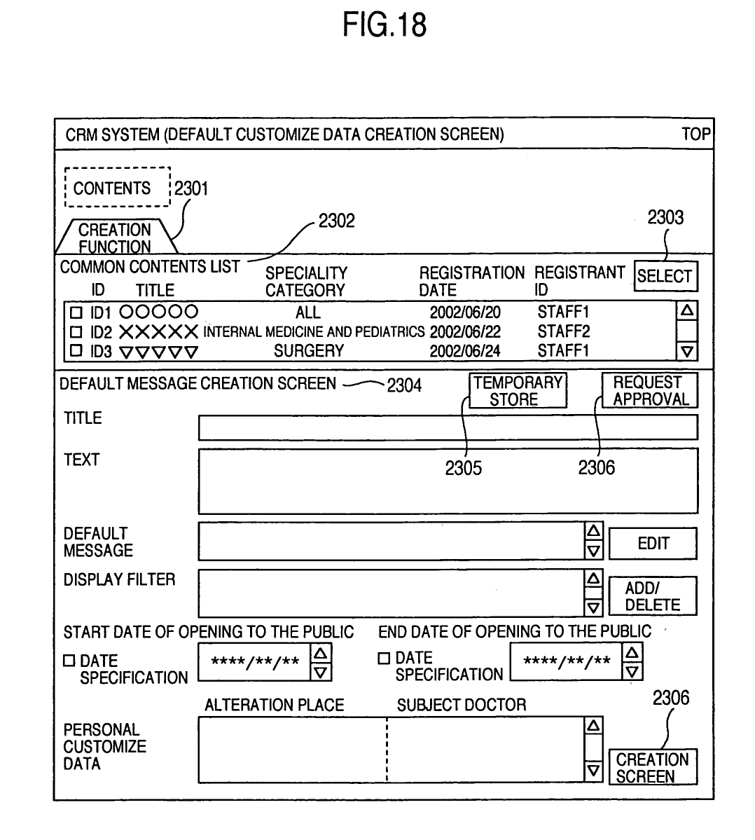

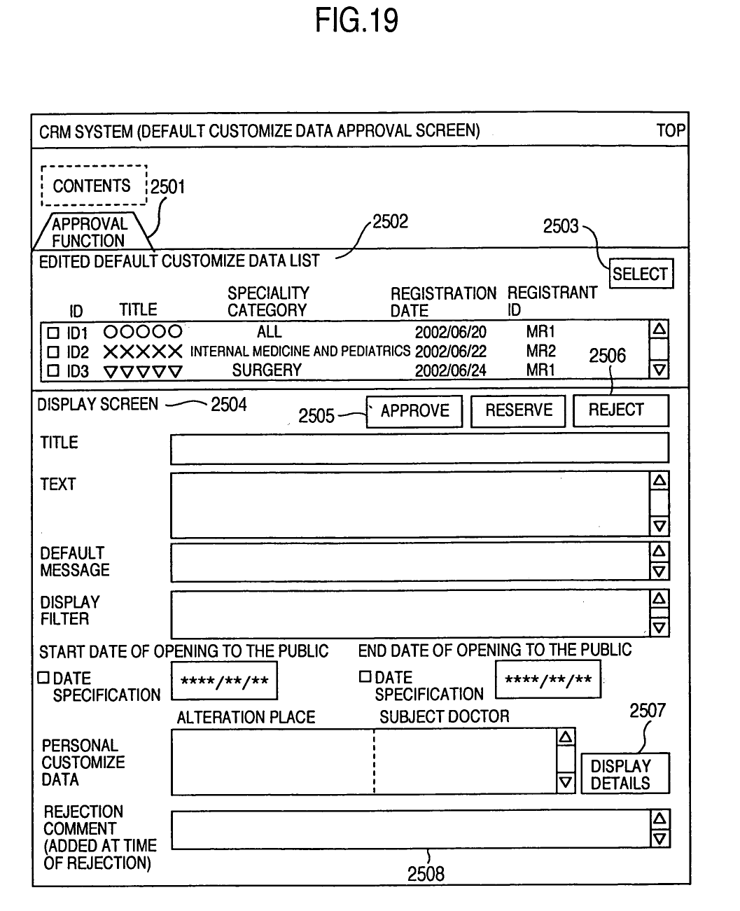

The user interface concerning the default customize data will now be described with reference to FIGS. 18 and 19.

FIG. 18 is a diagram showing an example of a creation screen for the default customize data 113 in the CRM system 100 according to an embodiment of the present invention.

FIG. 19 is a diagram showing an example of an approval screen for the default customize data 113 in the CRM system 100 according to an embodiment of the present invention.

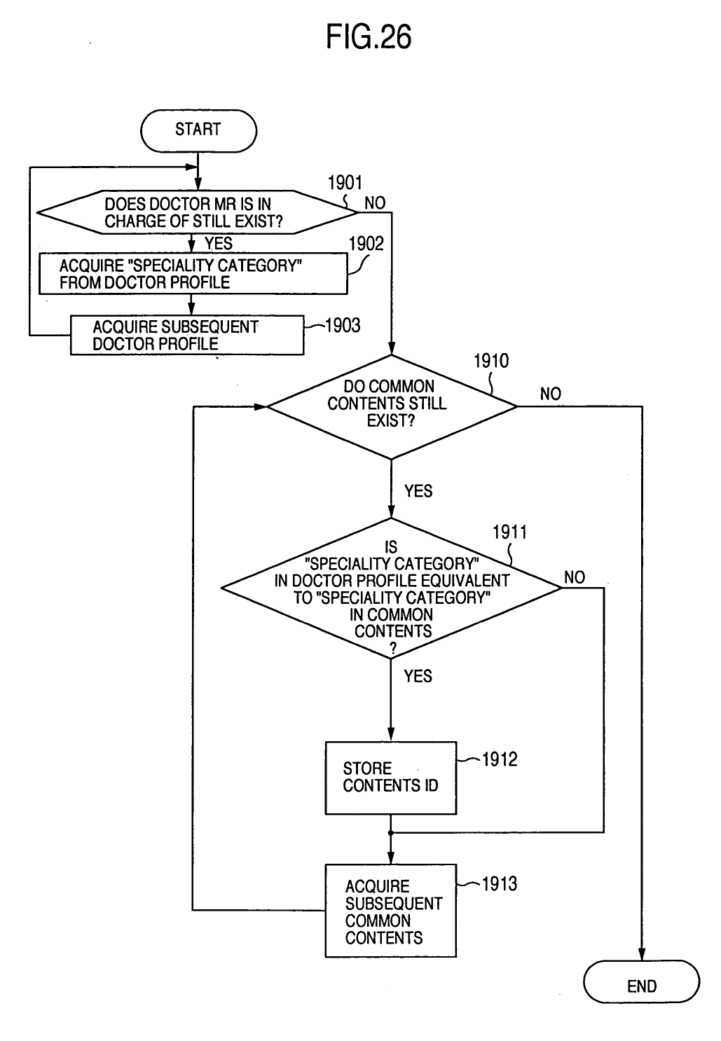

If the MR 11 opens a creation screen for the default customize data 113 and selects a creation function 2301 as shown in FIG. 18, suitable common contents 112 which become the subject of customize are selected on the basis of the MR profile 122 and displayed as a list (2302). The processing of selecting common contents 112 will be described in detail later with reference to flow charts shown in FIGS. 26 to 29.

If the MR 11 selects common contents 112 to be edited from the list and depresses a selection button 2303, then pre-editing default customize data 1200 corresponding to the selected common contents 112 is created on the basis of the doctor profile 121 for doctors the MR is in charge of and the market extension advertisement situation data 303, and displayed on a creation screen 2304.

The MR 11 suitably corrects the pre-editing default customize data 300 according to the doctors 12 the MR 11 is in charge of, and thereby creates edited default customize data 302.

The default customize data is data which becomes the default for the customize of all doctors 12 the MR 11 is in charge of.

When it is desired to effect further fine corrections on a specific doctor 12 the MR 11 is in charge of, the MR 11 depresses a creation screen button 2306 for personal customize data 114, and creates the edited personal customize data 401.

Thereafter, the MR 11 depresses an approval request button 2306, and thereby requests the MR manager 154 to approve the edited default customize data 1201 and the edited personal customize data 1301. When preserving the edited default customize data 1201 and the edited personal customize data 1301 without requesting the approval, the MR 11 depresses a temporary storage button 2035.

If an approval request for the edited default customize data 1201 is issued by the MR 11, then the MR manager 14 selects an approval function tab 2501 as shown in FIG. 19 and thereby displays a list of the edited default customize data 1201 (2502). By selecting edited default customize data 302 and depressing a selection button 2503, the contents are displayed on a display screen 2504. The MR manager 14 may depress a detail display button 2507 and display detailed contents in order to check the contents.

When approving the edited default customize data 1201, the MR manager 14 depresses an approve button 2505. When rejecting the edited default customize data 1201, the MR manager 14 describes a rejection reason 2508 and depresses a rejection button 2506.

By the way, in this screen, approval and rejection for the edited personal customize data 1301 can also be conducted.

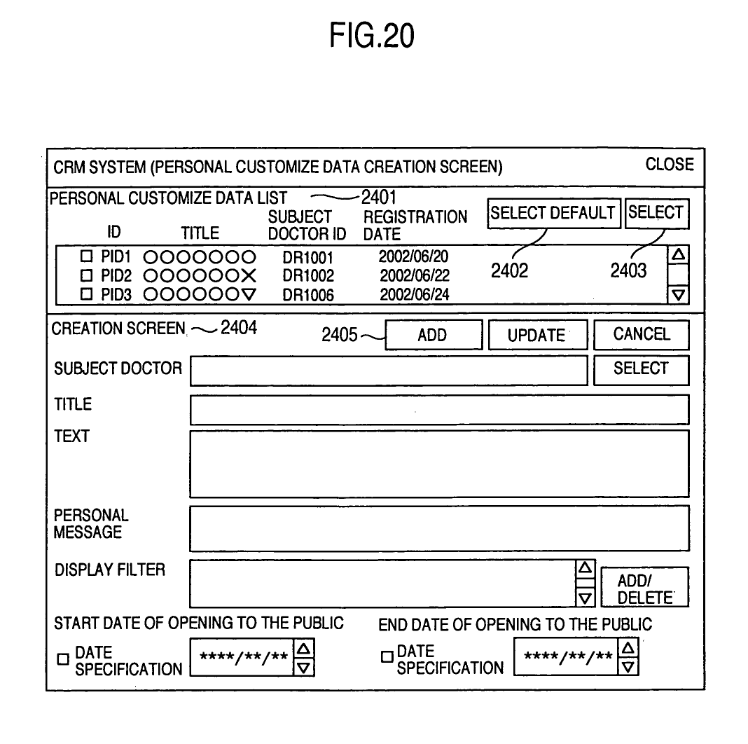

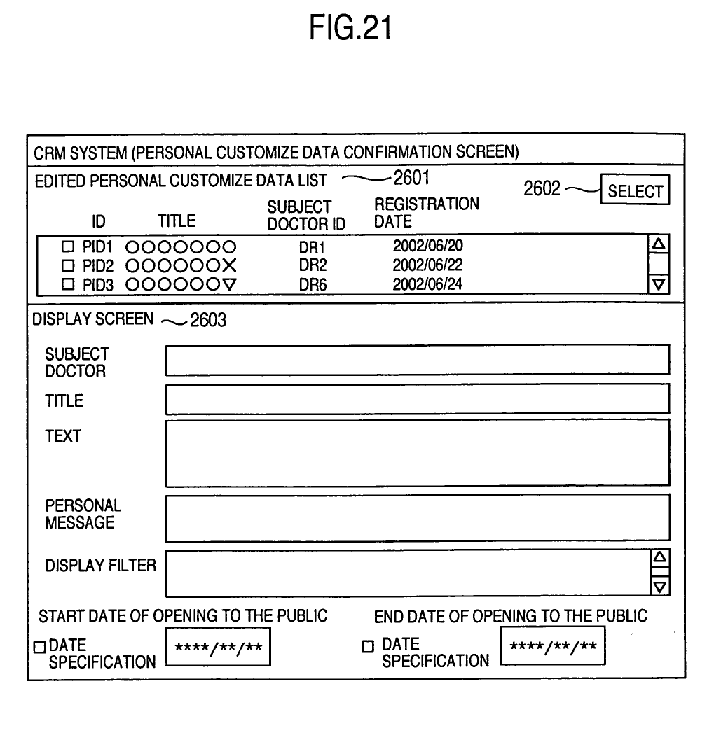

The user interface concerning the personal customize data will now be described with reference to FIGS. 20 and 21.

FIG. 20 is a diagram showing an example of a creation screen for the personal customize data 114 in the CRM system 100 according to an embodiment of the present invention.

FIG. 21 is a diagram showing an example of a confirmation screen for the personal customize data 114 in the CRM system 100 according to an embodiment of the present invention.

If the MR 11 depresses a personal customize creation screen button 2306 in the default customize data editing screen, then a creation screen for the personal customize data 114 is opened, and created default customize data is displayed in a personal customize data list 2401 as shown in FIG. 20.

If the MR 11 selects edited personal customize data 401 and depresses a selection button 2403, then the selected edited personal customize data 401 is displayed on the creation screen. If the MR 11 depresses a default selection button 2402, then contents of the edited default customize data 302 are displayed on a creation screen 2402.

In the description of the present embodiment, personal customize data can be created in the default customize data creation screen as well, and both the edited personal customize data 401 and the edited default customize data 302 created on the default customize data creation screen can be edited and updated on the personal customize data creation screen.

As another embodiment, only the creation of the default customize data may be conducted on the default customize data creation screen. On the personal customize data creation screen, only the edited default customize data 302 created on the default customize data creation screen may be taken in and edited.

If the MR 11 edits the contents displayed on the creation screen 2404 and depresses an addition button 2405, then the edited personal customize data is added.

If the MR 11 opens a screen for ascertaining the personal customize data 114 in order to ascertain the contents of the personal customize data 114, then a list of the edited personal customize data 1301 is displayed in a personal customize data list 2601 as shown in FIG. 21.

If the MR 11 selects the edited personal customize data 1301 and depresses a selection button 2602, then the selected edited personal customize data 1301 is displayed on a display screen 2603.

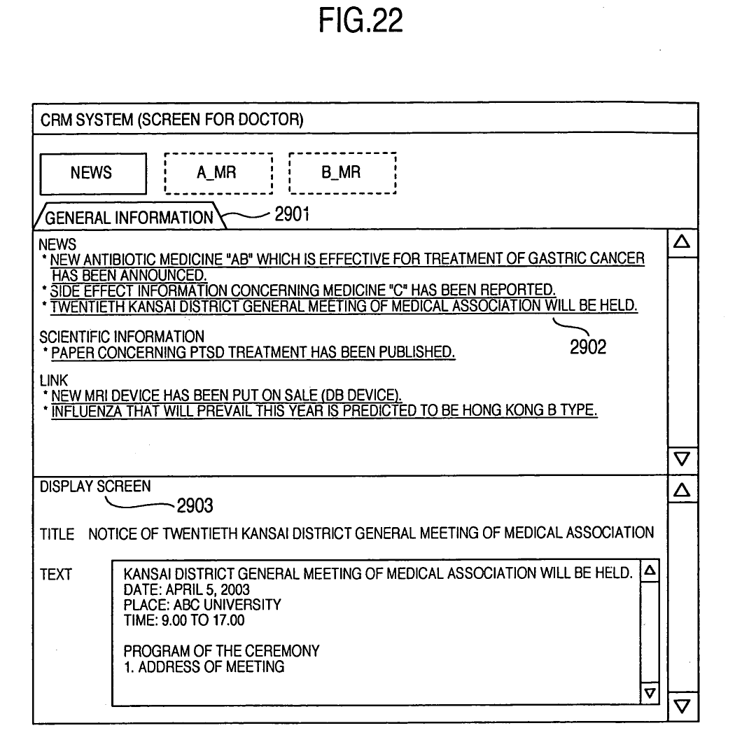

The user interface provided in the portal site will now be described with reference to FIGS. 22 to 24.

FIGS. 22 to 24 are diagrams showing examples of a screen for doctor in the portal site in the CRM system 100.

As for display contents in FIG. 22, general information is displayed. In this way, it is also possible for the doctor 12 to select general information 2901, which does not use the portlet 143 prepared by the MR 11 in charge. In this case, the displayed contents 201 become a list of the common contents 112. If the doctor 12 selects common contents 112 desired to be displayed, then contents of the common contents are displayed on 2902 and a display screen 2903.

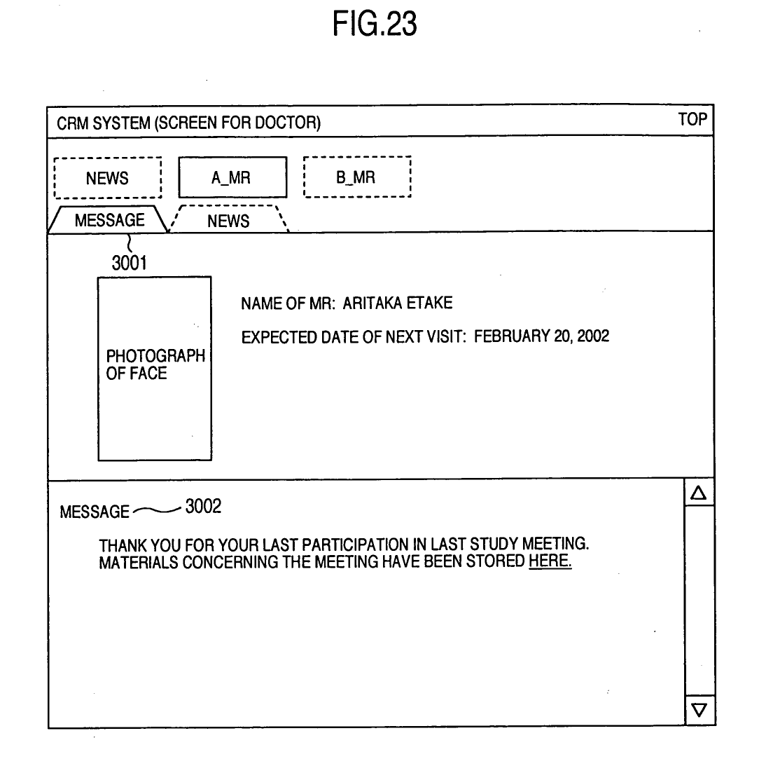

FIG. 23 shows an example in which contents are customized for a doctor. If the doctor 12 uses the portlet 143 prepared by the MR in charge and selects a message 3001, then personal contents that are a message in category created by the MR 151 are displayed as a message 3002.

Note that the MR ID of A_MR enters a column of MR ID 302-C in the portlet management table shown in FIG. 3.

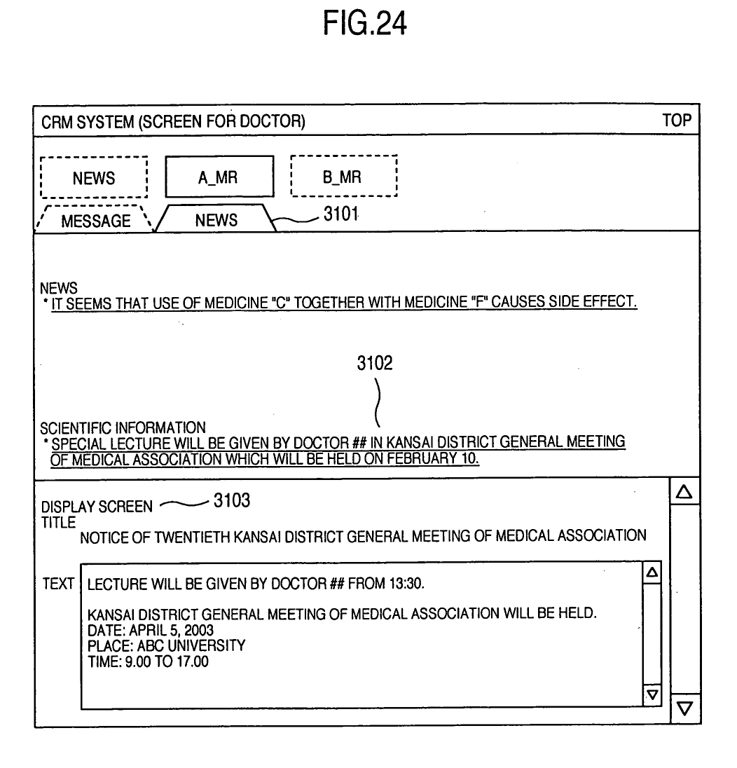

FIG. 24 also shows an example in which contents are customized in order to provide news dedicated to the doctor.

If in this case the doctor uses the portlet prepared by the MR 151 in charge of the doctor and selects news 3101, then a list is generated on the basis of the default customize data 113 and the personal customize data 114.

If data 3102 to be displayed is selected, then contents corresponding to a display screen 3103 are displayed.

4. Processing in CRM System

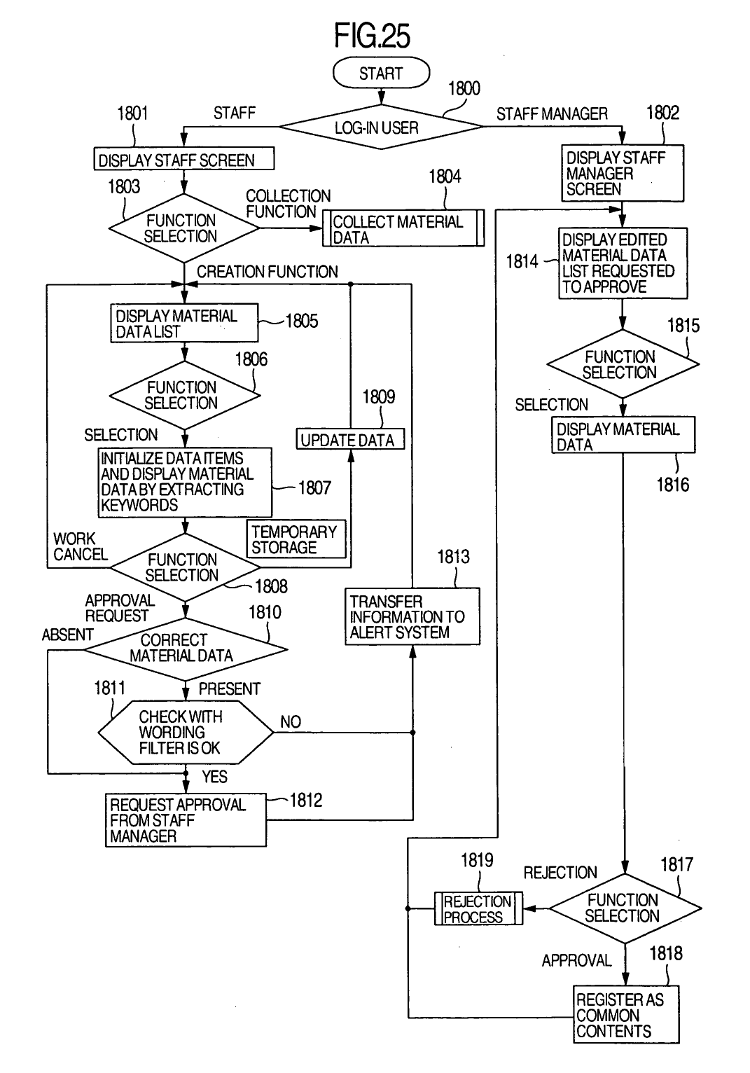

Processing in a CRM system according to an embodiment of the present invention will now be described with reference to FIGS. 25 to 32.

First, processing of creating the common contents will now be described with reference to FIG. 25.

FIG. 25 is a flow chart showing processing of creating the common contents.

First, if log-in is effected by the staff 10 or the staff manager 13 and the processing is started, then a decision concerning the log-in user is made (step 1800).

If the log-in user is the staff 10, then staff screen display is conducted (step 1801). In the case of the staff manager, staff manager screen display is conducted (step 1802).

In the case of the staff screen display, function selection is displayed and the next input (request) is waited for. Upon arrival of a request, the request is discriminated (step 1803). If the request is “(material data) collection function,” then the material data collection screen shown in FIG. 15 is displayed and material data collection is performed. If the collection of the material data is finished and the screen is closed, then a subsequent input (request) is waited for again.

If the request is “(common contents) creation function,” then the system displays the common contents creation screen shown in FIG. 16, and conducts common contents creation. As shown in FIG. 16, the list of the material data is displayed on the common contents creation screen (step 1805). At this time, items other than the selected display subjects are inactivated so as not to accept inputs. Thereafter, the system waits for arrival of the next input (request). Upon arrival of a request, the request is discriminated (step 1806). If the request is “selection,” then contents of the selected material data are displayed (step 1807). At this time, in order to reduce the burden on the staff, initialization of respective parameter items is simultaneously performed by extraction of keywords prepared by the system.

Thereafter, buttons of “request approval,” “temporary store,” and “cancel work” are activated, and the selection button is inactivated. Thereafter, the system returns to the state in which the next input (request) is waited for. Upon arrival of a request, the request is discriminated (step 1808). If the request is “temporary store” and an alteration is effected on items of the material data, then contents of the material data are updated, and thereafter the system returns to the state in which the next input (request) is waited for. If the request is “request approval,” then approval request processing is started. If the approval request is issued, then a decision is made whether the material data has been corrected (step 1810). If the material data has been corrected, then approval from the staff manager 13 is requested (step 1811). If correction has been performed, then a check is conducted by using a wording filter. If there are no problems as a result of the check, then processing of requesting approval from the staff manager is conducted (step 1812). The edited material data is brought into the approval request state, and information is transferred to the alert system (step 1813), and notice of approval request is given to the staff manager. If there is a problem as a result of the check, then the approval request is not issued, but information is transferred to notify the alert system that there has been a problem as a result of the check (step 1810). Thereafter, the system returns its state to the material data list display state 1805, in which only the selection button is activated, and waits for the next input (request).

Although not illustrated in the flow, the processing can be finished by conducting the processing of closing the common contents creation screen shown in FIG. 16.

In the case where the log-in user is the staff manager 13, the common contents approval screen is displayed and common contents approval processing is conducted.

First, a list of edited material data approval of which from the staff manager 13 is requested is displayed (step 1814), and buttons other than the request are inactivated, then the system returning to the state in which the next input (request) is waited for. Upon arrival of a request, the request is discriminated (step 1815). If the request is “selection,”, then material data selected by the staff are displayed (step 1816), and an approval button and a rejection button are activated, then the system returning to the state in which the next input (request) is waited for.

Upon arrival of a request, the request is discriminated (step 1817). If the request is “approve,”, then the displayed contents are registered as common contents (step 1818), thus common contents being created.

If the request is “reject,”, then rejection processing on the edited material data is conducted (step 1819). Thereafter, the system returns to the material data list display state 1814, and the next input (request) is waited for.

Although not illustrated, the processing can be finished by closing the common contents approval screen and performing the log-off.

Processing of acquiring a list of the common contents 112, which becomes the basis for creation when executing the default customize data creation function 132 in the CRM system 100, will now be described with reference to FIGS. 26 to 29.

FIGS. 26 to 29 are flow charts showing processing of acquiring a list of the common contents 112, which becomes the basis for creation when executing the default customize data creation function 132 in the CRM system 100.

When acquiring a list of the common contents 112, the list is acquired by using all of four kinds of relevant information shown in the following flow charts. Although not illustrated in the flow charts, finally sorting is performed according to contents IDs, and duplicated data are excluded.

In a flow chart shown in FIG. 26, processing used for selecting common contents 112 relating to a doctor 12 the MR 11 is in charge of, on the basis of a specialty category is shown.

In this processing, a decision is first made whether a doctor the MR 11 is in charge of still exists on the basis of the ID of doctor the MR is in charge of (905 in FIG. 9) in the MR profile (step 1901). If a doctor the MR is in charge of exists, then a specialty category (806 in FIG. 8) is acquired from the doctor profile (step 1902), a subsequent doctor profile is acquired (step 1903), and the processing returns to the decision 1901 whether a doctor the MR is in charge of still exists. Subsequently, a decision is made whether common contents still exist (step 1910). If common contents do not exist, then the processing is finished. If common contents still exist, then a decision is made whether the acquired specialty category is equivalent to the specialty category (404-a in FIG. 4) in the common contents (step 1911). If the specialty categories are not equivalent, then subsequent common contents are acquired (step 1913). If the specialty categories are equivalent, then the contents ID is stored (step 1912) and subsequent common contents are acquired (step 1913). After the acquisition of the subsequent common contents, the processing returns to the decision 1913 whether common contents still exist.

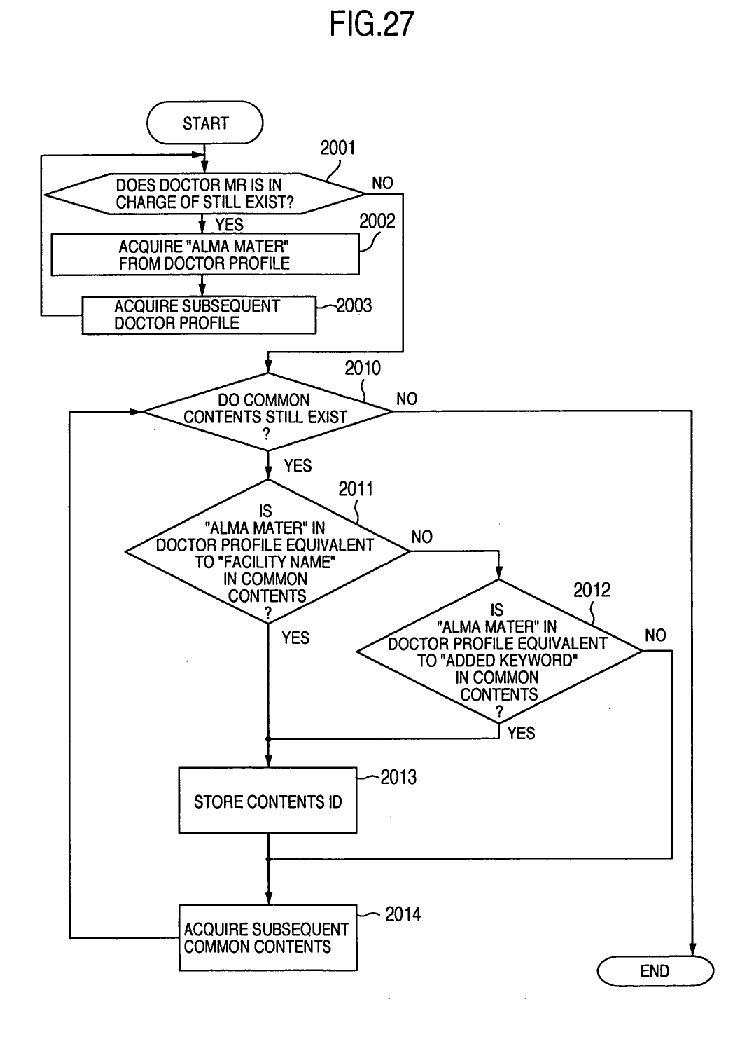

In a flow chart shown in FIG. 27, the MR 11 selects contents from the alma mater when selecting common contents 112 relating to a doctor 12 the MR is in charge of.

In this processing, a decision is first made whether a doctor the MR 11 is in charge of still exists, on the basis of the ID of doctor (905 in FIG. 9) MR is in charge of in the MR profile (step 2001). If a doctor the MR 11 is in charge of exists, then the alma mater (808 in FIG. 8) is acquired from the doctor profile (step 2002), a subsequent doctor profile is acquired (step 2003), and the processing returns to the decision 2001 whether a doctor the MR 11 is in charge of still exists.

Subsequently, a decision is made whether common contents still exist (step 2010). If common contents do not exist, then the processing is finished. If common contents still exist, then a decision is made whether the alma mater in the doctor profile is equivalent to the facility name (404-c shown in FIG. 4) in the common contents (step 2011). If the alma mater is equivalent to the facility name, then the contents ID is stored (step 2013). If the alma mater is not equivalent to the facility name, then a decision is made whether the alma mater in the doctor profile is equivalent to an added keyword (402-f in FIG. 4) in the common contents (step 2012). If the alma mater is not equivalent to the added keyword, then subsequent common contents are acquired (step 2014). If the alma mater is equivalent to the added keyword, then the contents ID is stored (step 2013). After the contents ID has been stored, subsequent common contents are acquired (step 2014) and the processing returns to the decision step 2010 for determining whether common contents exist.

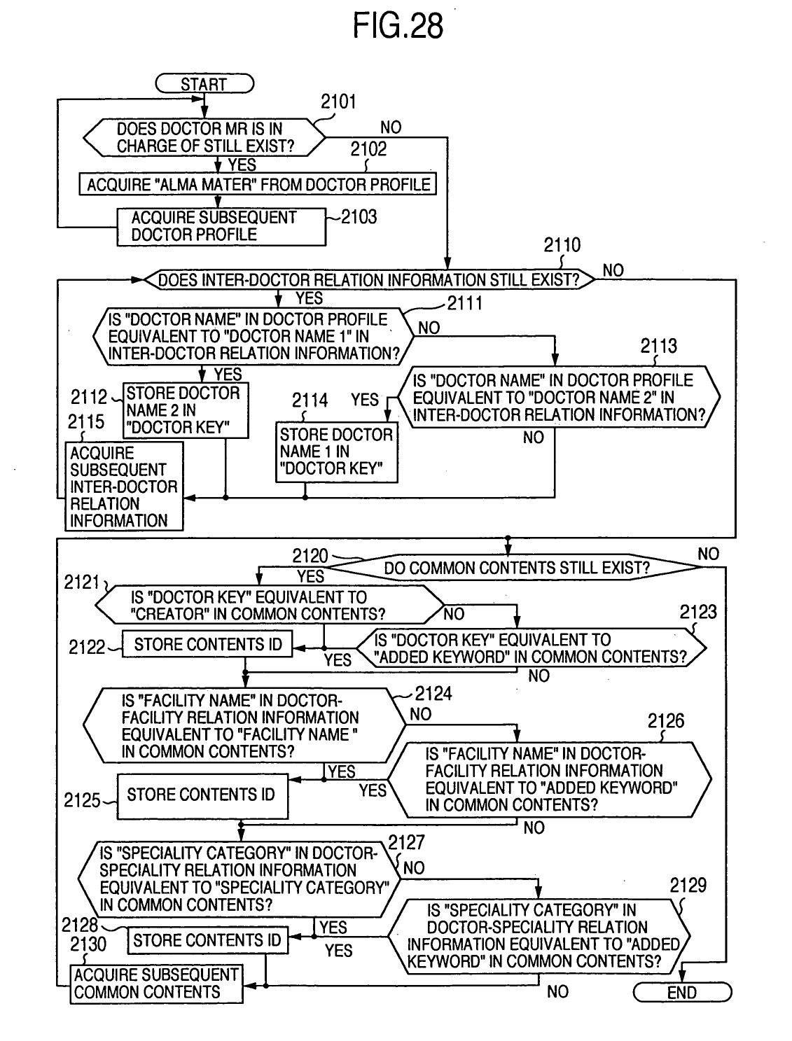

In a flow chart shown in FIG. 28, the MR 11 selects contents from the inter-doctor relation information 610 when selecting common contents 112 relating to a doctor 12 the MR 11 is in charge of.

In this processing, a decision is first made whether a doctor the MR 11 is in charge of still exists on the basis of the ID of doctor the MR 11 is in charge of (905 in FIG. 9) in the MR profile (step 2101). If a doctor the MR 11 is in charge of exists, then a doctor name is acquired from the doctor profile (step 2102), a subsequent doctor profile is acquired (step 2103), and the processing returns to the decision step 2101 for determining whether a doctor the MR 11 is in charge of still exists.

Subsequently, a decision is made whether inter-doctor relation information still exists (step 2110).

If relation information exists, then a decision is made whether a doctor name in the doctor profile is equivalent to a doctor name 1 in the inter-doctor relation information (step 2111). If the doctor names are equivalent to each other, then a doctor name 2 is stored as a doctor key (step 2112) and subsequent data in the inter-doctor relation information is acquired (step 2115). If the doctor names are not equivalent to each other, then a decision is made whether a doctor name in the doctor profile is equivalent to a doctor name 2 in the inter-doctor relation information (step 2113). If the doctor names are equivalent to each other, then the doctor name 1 is stored as a doctor key (step 2114) and subsequent data in the inter-doctor relation information is acquired (step 2115). If the doctor names are not equivalent to each other, then subsequent data in the inter-doctor relation information is acquired (step 2115). After subsequent data in the inter-doctor relation information has been acquired, the processing returns to the decision step 2110 for determining whether inter-doctor relation information still exists.

If inter-doctor relation information does not exist, then a decision is made whether common contents still exist (step 2120). If common contents do not exist, then the processing is finished. If common contents still exist, then a decision is made whether the doctor key and common contents have something in common, such as whether the doctor is equivalent to a creator of paper (step 2121). If equivalence is found, then contents name is stored (step 2122). If equivalence is not found, then a decision is made whether the doctor key is equivalent to the added keyword in the common contents (step 2123). If the doctor key is equivalent to the added keyword, then the contents ID is stored (step 2122).

Subsequently, a decision is made whether a facility name in the doctor-facility relation information is equivalent to the position (402-c in FIG. 4) in the common contents (step 2124). If they are equivalent to each other, then the contents ID is stored (step 2125). If they are not equivalent to each other, then a decision is made whether a facility name in the doctor-facility relation information is equivalent to the added keyword in the common contents (step 2126). If they are equivalent to each other, then the contents ID is stored (step 2125). Subsequently, a decision is made whether a specialty category in the doctor-specialty category relation information is equivalent to a specialty category in the common contents (step 2127). If the categories are equivalent to each other, then the contents ID is stored (step 2128). If the categories are not equivalent to each other, then a decision is made whether a specialty category in the doctor-specialty category relation information is equivalent to the added keyword in the common contents (step 2129). If they are equivalent to each other, then the contents ID is stored (step 2128). Subsequently, subsequent common contents are acquired (step 2130), and the processing returns to the decision (step 2120) whether common contents still exist.

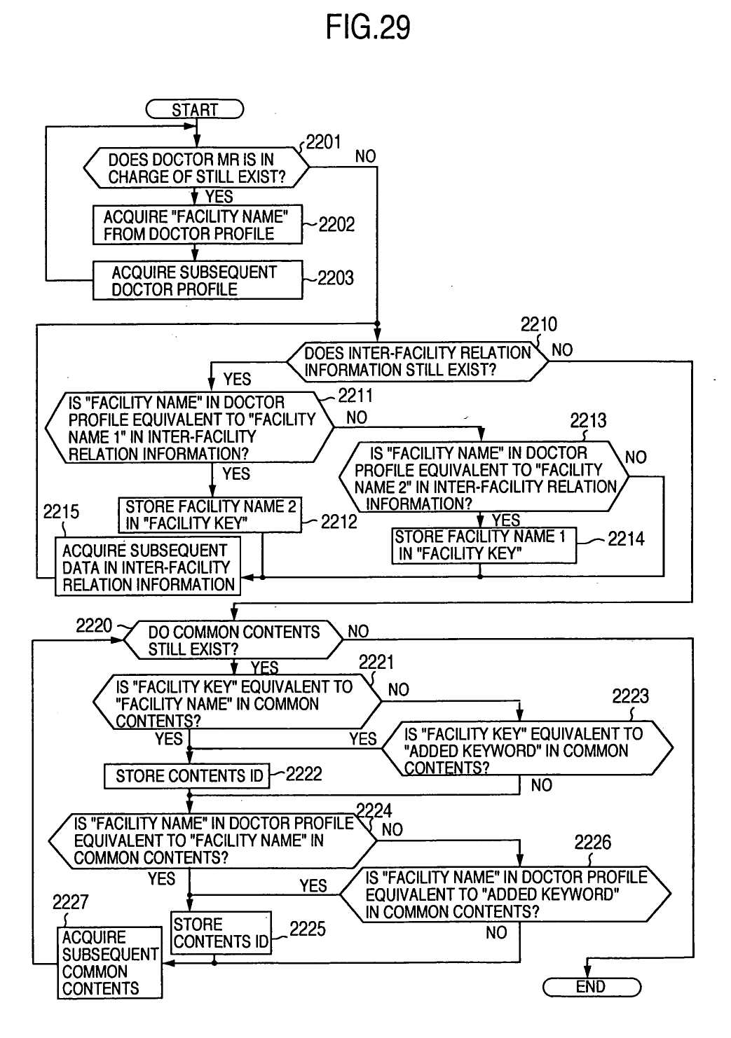

In a flow shown in FIG. 29, the MR 11 selects contents from a facility to which a doctor belongs when selecting common contents 112 relating to a doctor 12 the MR is in charge of.

In this processing, a decision is first made whether a doctor the MR 11 is in charge of still exists on the basis of the ID of doctor the MR is in charge of (905 in FIG. 9) in the MR profile (step 2201). If a doctor the MR is in charge of exists, then a facility name is acquired from the doctor profile (step 2202), a subsequent doctor profile is acquired (step 2203), and the processing returns to the decision step 2201 for determining whether a doctor the MR is in charge of still exists.

Subsequently, a decision is made whether inter-facility relation information still exists (step 2210). If relation information exists, then a decision is made whether a facility name in the doctor profile is equivalent to a facility name 1 in the inter-facility relation information (step 2211).

If they are equivalent to each other, then a facility name 2 is stored as a facility key (step 2212) and subsequent data in the inter-facility relation information is acquired (step 2215). If they are not equivalent to each other, then a decision is made whether a facility name in the doctor profile is equivalent to a facility name 2 in the inter-facility relation information (step 2213). If they are equivalent to each other, then the facility name 1 is stored as a facility key (step 2214) and subsequent data in the inter-facility relation information is acquired (step 2215). If they are not equivalent to each other, then subsequent data in the inter-facility relation information is acquired (step 2215).

After subsequent data in the inter-facility relation information has been acquired, the processing returns to the decision step 2210 for determining whether inter-facility relation information still exists. If inter-facility relation information does not exist, then a decision is made whether common contents still exist (step 2220). If common contents do not exist, then the processing is finished. If common contents still exist, then a decision is made whether the facility key is equivalent to a facility name in the common contents (step 2221). If they are equivalent to each other, then the contents ID is stored (step 2222). If they are not equivalent to each other, then a decision is made whether the facility key is equivalent to the added keyword in the common contents (step 2223). If they are equivalent to each other, then the contents ID is stored (step 2222).

Subsequently, a decision is made whether a facility name in the doctor profile is equivalent to the position (402-c in FIG. 4) in contents included in the common contents (step 2224). If they are equivalent to each other, then the contents ID is stored (step 2225). If they are not equivalent to each other, then a decision is made whether a facility name in the doctor profile is equivalent to the added keyword in the common contents (step 2216). If they are equivalent to each other, then the contents ID is stored (step 2225). Subsequently, subsequent common contents are acquired (step 2227), and the processing returns to the decision step 2220 for determining whether common contents still exist.

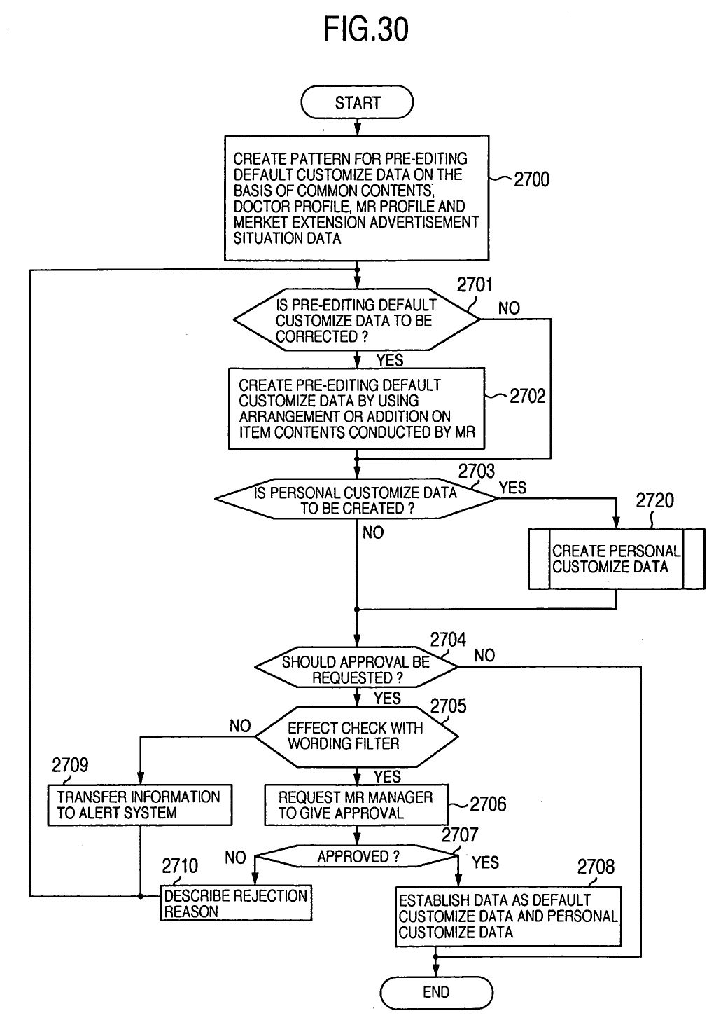

Processing of creating default customize data or personal customize data and obtaining approval will now be described with reference to FIG. 30.

FIG. 30 is a flow chart showing the processing of creating default customize data or personal customize data and obtaining approval.

First, in order to reduce the editing work conducted by the MR 11, a pattern for pre-editing default customize data is first created on the basis of common contents, the doctor profile, the MR profile and the market extension advertisement situation data (step 2700), and the pattern is added to items of the default contents. Subsequently, a decision is made whether the MR has corrected the pre-editing default customize data (step 2701). If the MR has corrected the pre-editing default customize data, then pre-editing default customize data is created by conducting arrangement or addition of contents of editing data items (step 2702).

Subsequently, a decision is made whether the MR 11 attempts to create personal customize data (step 2703). When the MR 11 attempts to create personal customize data, personal customize data is created (step 2720). Processing of creating the personal customize data will be described in detail with reference to the following flow chart.

Subsequently, if the MR 11 has depresses an approval request button when the MR 11 depresses a button (step 2704), then the MR manager 14 is requested to give approval. Although not illustrated, edited default customize data is created and the processing is finished if a temporary storage button is depressed. In the case where approval is requested, a check using the wording filter is effected (step 2705). If there are no problems in the check, the MR manager 14 is requested to give approval (step 2706).

Subsequently, a decision is made whether the MR manager 14 has given approval (step 2707). If approval is not given, then a reason of rejection is acquired (step 2710) and the processing returns to the decision step 2701 for determining whether to correct the pre-editing default customize data. If the correction is approved, then the data is registered as default customize data (step 2708) and the processing is finished. If there is a problem in the check using the wording filter, then the information is transmitted to the alert system (step 2709) and the processing returns to the decision step 2701 for determining whether to correct the pre-editing default customize data.

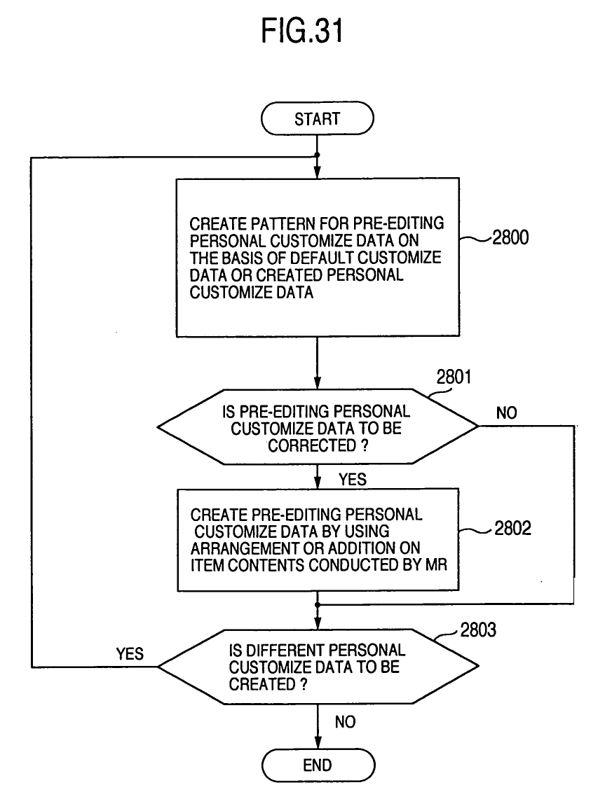

Processing of creating the personal customize data will now be described with reference to FIG. 31.

FIG. 31 is a flow chart showing the processing of creating the personal customize data.

This processing corresponds to the step 2720 in the flow chart shown in FIG. 30.

According to selection effected by the MR 11, a pattern for pre-editing personal customize data is first created on the basis of the default customize data or the created personal customize data (step 2800). Subsequently, a decision is made whether the pre-editing personal customize data has been corrected (step 2801). If corrections have been performed, the MR 11 conducts arrangement or addition of contents of data items, and thereby pre-editing personal customize data is created (step 2802).

Subsequently, a decision is made whether the MR 11 inputs different data and attempts to create different personal customize data (step 2803). If data is to be created, then the processing returns to the decision 2801 for determining whether the pre-editing personal customize data has been corrected. If data is not to be created, then the processing is finished.

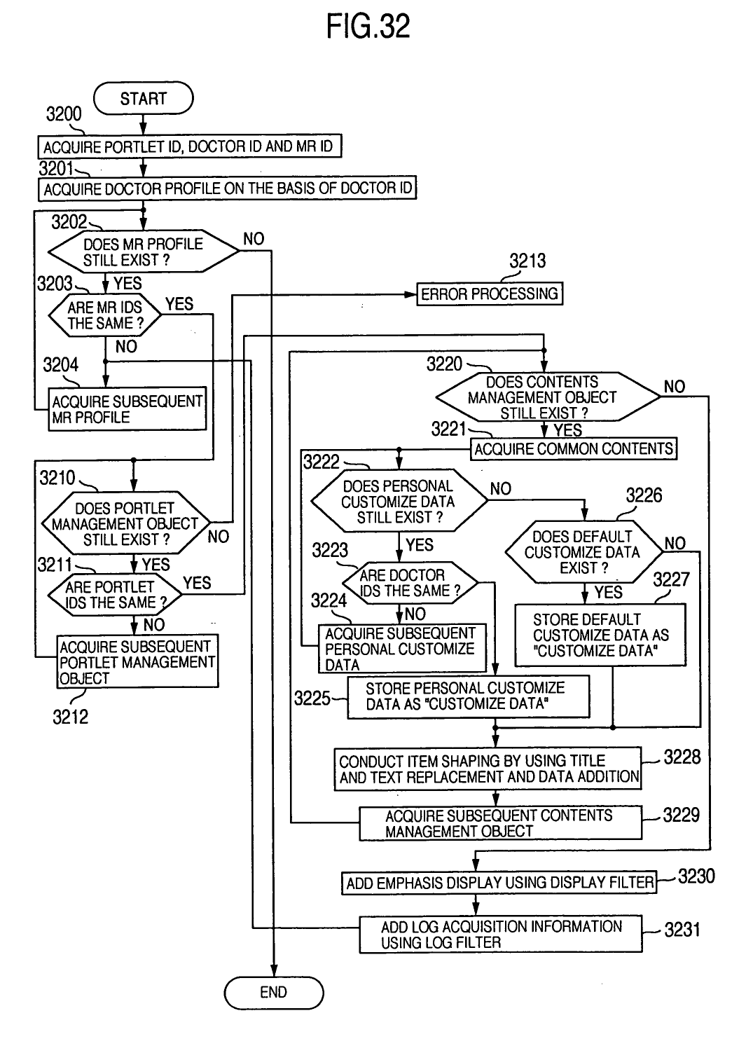

Processing of displaying a web page for doctor in the portal site in the CRM system 100 will now be described with reference to FIG. 32.

FIG. 32 is a flow chart showing the processing of displaying a web page for doctor in the portal site in the CRM system 100.

First, when the doctor 12 has logged in on a log-in screen preceding a screen for displaying a doctor-oriented web page, a doctor ID of the doctor 12 who has logged in and a list of IDs of MRs in charge of the doctor, in the doctor profile are acquired (step 3200). On the basis of the acquired doctor ID and MR ID, portlet management objects and contents management objects are generated, and a portlet dedicated to the doctor is generated.

Subsequently, by following the link relations shown in FIG. 10, a portlet ID of a portlet to be displayed, the ID of the doctor who has logged in, and the MR ID are acquired from the system (step 3200). Subsequently, a doctor profile 121 is acquired on the basis of the doctor ID (step 3201).

Subsequently, a decision is made whether an MR profile 122 indicated by the doctor profile 121 still exists (step 3202). If an MR profile does not exist, then the processing is finished. If an MR profile exists, then a decision is made whether the MR IDs are the same (step 3203). If the MR IDs are different from each other, then a subsequent MR profile 122 is acquired (step 3204) and the processing returns to the decision step 3202 for determining whether an MR profile 122 exists. If the MR IDs are the same, then a decision is made whether a portlet management object. 1000 indicated by the MR profile 122 still exists (step 3210). If there are no objects, error processing is conducted (step 3213). If an object exists, then a decision is made whether the portlet is a portlet to be displayed by the portlet management object 1000 by determining whether the portlet IDs are the same. If the portlet IDs are different, then a subsequent portlet management object 1000 is acquired (step 3212), and the processing returns to the decision step 3210 for determining whether a portlet management object 1000 exists. If the portlet IDs are the same, then a decision is made whether a contents management object 1001 indicated by the portlet management object 1000 still exists (step 3220). If there are no objects, then emphasis display of the text using the display filter is conducted (step 3230). As a result, emphasis display of a place customized in the common contents can be conducted. And access log acquisition information using the log filter is added (step 3231), and the processing returns to acquisition step 3204 of a subsequent MR profile 122. If an object exists, then common contents are acquired (step 3221).

Subsequently, a decision is made whether personal customize data 114 still exists (step 3222). If data exists, then a decision is made whether the personal customize data is data for the doctor desiring the display, by determining whether the doctor IDs are the same (step 3223). If the doctor IDs are different, then subsequent personal customize data 114 is acquired (step 3224), and the processing returns to the decision step 3222 for determining whether personal customize data 114 exists. If the doctor IDs are the same, then the personal customize data 114 is stored as the customize data for display. If there are no personal customize data 114, then a decision is made whether default customize data exists (step 3226). If data exists, then the default customize data 113 is stored as customize data for display (step 3227). Subsequently, item shaping using title and text replacement and data addition is conducted on the basis of customize data stored for display (step 3228), and a subsequent contents management object 1001 is acquired (step 3229), then the processing returning to the decision step 3220 for determining whether a contents management object 1001 exists.

5. Advantages Obtained when a Portal Site is Created by the CRM System of the Present Invention

When a portal site is created by the CRM system of the present invention, the following advantages are obtained.

(1) Services provided by the customer portal site can be made to meet needs of respective customers more satisfactorily.

(2) The sales task member can create personal contents for a specific customer with labor reduced as compared with the conventional technique.

(3) The sales task member can make an analysis as to how to customize common contents and create personal contents in order to increase the customer access.

The present invention brings about the following subsidiary advantages.

(4) Since the situation of sales task activities performed by sales task members appears on the customer portal site, it is possible to grasp the situation of sales task activities which has been difficult for the manager to grasp.

(5) In the customer portal system, first-hand voice of customers which could be known only indirectly via a sales task member in the conventional art can be acquired.

According to the present invention, it is possible to provide a portal site creation method whereby a portal site capable of providing fine service meeting respective customers can be implemented when implementing a customer portal site in a CRM system and labor required for creation and operation of the portal site can be saved.

It should be further understood by those skilled in the art that although the foregoing description has been made on embodiments of the present invention, the present invention is not limited thereto and various changes and modifications may be made without departing from the spirit of the present invention and the scope of the appended claims.

What is claimed is:

1. A CRM (Customer Relation Management) system for providing a customer with contents and displaying the contents by using a computer system, the CRM system comprising:
common contents created for unspecific customers;
personal contents created for specific customers;
common contents management means for managing the common contents; and
personal contents management means for managing the personal contents,
wherein the common contents and the personal contents are combined, and thereby information specialized for each customer is generated and displayed.

2. The CRM system according to claim 1, wherein
when combining the common contents and the personal contents, and thereby generating information specialized for each customer,
default contents serving as default are generated, and information specialized for each customer is generated by way of the default contents.

3. The CRM system according to claim 2, wherein
when generating the default contents,
with respect to a certain specific customer, contents of the common contents are customized on the basis of a profile of the customer and a profile of a sales task member in charge of the customer.

4. The CRM system according to claim 2, wherein each of items in the common contents can be classified and defined as to whether it can be customized as default.

5. The CRM system according to claim 2, further comprising information related to each customer,
wherein when generating information specialized for each customer, information specialized for each customer is generated by referencing the information related to the customer.

6. The CRM system according to claim 5, wherein when generating information specialized for each customer, information related to the customer is retrieved from the common contents and presented as a subject of customization.

7. A portal site creation method for creating a portal site to provide a customer with contents and display the contents by using a computer system, the portal site creation method comprising the steps of:
creating common contents for unspecific customers;
creating personal contents for specific customers;
combining the created common contents and the created personal contents and thereby generating information specialized for each customer; and
displaying the information specialized for each customer on a portal site.

8. The portal site creation method according to claim 7, wherein the step of combining the created common contents and the created personal contents and thereby generating information specialized for each customer comprises the step of:
generating default contents serving as default, and generating information specialized for each customer by way of the default contents.

9. The portal site creation method according to claim 7, wherein the step of displaying the information specialized for each customer on a portal site comprises the step of:
displaying the information specialized for each customer with emphasis.

10. A portal site creation support program for creating a portal site to provide a customer with contents and display the contents by using a computer system, the program including codes for performing:
a function of creating common contents for unspecific customers;
a function of creating personal contents for specific customers;
a function of combining the created common contents and the created personal contents and thereby generating information specialized for each customer; and
a function of displaying the information specialized for each customer on a portal site.

11. The portal site creation support program according to claim 10, wherein when executing the function of combining the created common contents and the created personal contents and thereby generating information specialized for each customer,
default contents serving as default are generated, and information specialized for each customer is generated by way of the default contents.

12. The portal site creation support program according to claim 10, wherein the computer system which executes the program comprises information related to each customer, and
when generating information specialized for each customer, the computer system references the information related to each customer, and generates information specialized for each customer.
